(19) United States
(12) Patent Application Publication
(10) Pub. No.: US 2026/0082269 A1
(43) Pub. Date: Mar. 19, 2026

(54) WIRELESS COMMUNICATION METHODS AND COMMUNICATION APPARATUSES

(71) Applicant: GUANGDONG OPPO MOBILE TELECOMMUNICATIONS CORP., LTD., Dongguan (CN)

(72) Inventors: Boren GUO, Dongguan (CN); Yali GUO, Dongguan (CN)

(21) Appl. No.: 19/392,095

(22) Filed: Nov. 17, 2025

Related U.S. Application Data
(63) Continuation of application No. PCT/CN2023/108683, filed on Jul. 21, 2023.

(51) Int. Cl. H04W 28/02; H04W 24/08

(52) U.S. Cl. CPC H04W 28/0268; H04W 24/08

(57) ABSTRACT

A first network element, configured to perform: transmitting a first message to a second network element, the first message being used to request quality of service (QoS) monitoring for a first packet delay. The first packet delay includes one or more of following packet delays: a packet delay between a first terminal device and an associated device of the first terminal device; or a packet delay between a user plane function (UPF) and a data network (DN)

### CROSS-REFERENCE TO RELATED APPLICATION

This application is a Continuation Application of International Application No. PCT/CN2023/108683 filed on July 21, 2023, which is incorporated herein by reference in its entirety.

### TECHNICAL FIELD

The present application relates to the technical field of communications, and more particularly, to a wireless communication method and a communication apparatus.

### BACKGROUND

In order to optimize the performance of communication systems, certain communication systems (e.g., new radio (NR) systems) have introduced a quality of service (QoS) monitoring mechanism. The QoS monitoring mechanism can achieve end-to-end QoS control of services.

With the increase of services scenarios in the communication systems, the demand for end-to-end QoS control of services has become more and more abundant, so that application scenarios of the QoS monitoring mechanism also need to be further enhanced. Therefore, how to enhance the QoS monitoring mechanism is an urgent problem to be solved.

### SUMMARY

The present application provides a wireless communication method and a communication apparatus. Various aspects of the present application are introduced below.

In a first aspect, a wireless communication method is provided, which includes: transmitting, by a first network element, a first message to a second network element, where the first message is used to request QoS monitoring for a first packet delay; and the first packet delay includes one or more of following packet delays: a packet delay between a first terminal device and an associated device of the first terminal device; or a packet delay between a user plane function (UPF) and a data network (DN).

In a second aspect, a wireless communication method is provided, which includes: receiving, by a second network element, a first message transmitted by a first network element, where the first message is used to request QoS monitoring for a first packet delay; and the first packet delay includes one or more of following packet delays: a packet delay between a first terminal device and an associated device of the first terminal device; or a packet delay between a UPF and a DN.

In a third aspect, a wireless communication method is provided, which includes: receiving, by a third network element, a second message transmitted by a second network element, where the second message is used to indicate the third network element to perform QoS monitoring on a first packet delay; and the first packet delay includes one or more of following packet delays: a packet delay between a first terminal device and an associated device of the first terminal device; or a packet delay between a UPF and a DN.

In a fourth aspect, a wireless communication method is provided, which includes: receiving, by a fourth network element, a third message transmitted by a third network element, where the third message is used to request the fourth network element to perform QoS monitoring on a packet delay between a UPF and a DN.

In a fifth aspect, a wireless communication method is provided, which includes: receiving, by a first terminal device, a fourth message transmitted by a third network element, where the fourth message is used to request the first terminal device to perform QoS monitoring on a packet delay between the first terminal device and an associated device of the first terminal device.

In a sixth aspect, a communication apparatus is provided, which is a first network element, and the communication apparatus includes: a transmitting module, configured to transmit a first message to a second network element, where the first message is used to request QoS monitoring for a first packet delay; and the first packet delay includes one or more of following packet delays: a packet delay between a first terminal device and an associated device of the first terminal device; or a packet delay between a UPF and a DN.

In a seventh aspect, a communication apparatus is provided, which is a second network element, and the communication apparatus includes: a first receiving module, configured to receive a first message transmitted by a first network element, where the first message is used to request QoS monitoring for a first packet delay; and the first packet delay includes one or more of following packet delays: a packet delay between a first terminal device and an associated device of the first terminal device; or a packet delay between a UPF and a DN.

In an eighth aspect, a communication apparatus is provided, which is a third network element, and the communication apparatus includes: a first receiving module, configured to receive a second message transmitted by a second network element, where the second message is used to indicate the third network element to perform QoS monitoring on a first packet delay; and the first packet delay includes one or more of following packet delays: a packet delay between a first terminal device and an associated device of the first terminal device; or a packet delay between a UPF and a DN.

In a ninth aspect, a communication apparatus is provided, which is a fourth network element, and the communication apparatus includes: a first receiving module, configured to receive a third message transmitted by a third network element, where the third message is used to request the fourth network element to perform QoS monitoring on a packet delay between a UPF and a DN.

In a tenth aspect, a terminal device is provided, which is a first terminal device, and the terminal device includes: a receiving module, configured to receive a fourth message transmitted by a third network element, where the fourth message is used to request the first terminal device to perform QoS monitoring on a packet delay between the first terminal device and an associated device of the first terminal device.

In an eleventh aspect, a communication apparatus is provided, which includes a processor, a memory and a communication interface, where the memory is configured to store one or more computer programs, and the processor is configured to call the one or more computer programs stored in the memory, to enable the communication apparatus to perform part or all of the steps of the method in any one of the first to fourth aspects.

In a twelfth aspect, a terminal device is provided, which includes a processor, a memory and a communication interface, where the memory is configured to store one or more computer programs, and the processor is configured to call the one or more computer programs stored in the memory, to enable the terminal device to perform part or all of the steps of the method in the fifth aspect.

In a thirteenth aspect, the embodiments of the present application provide a communication system, which includes the communication apparatus and/or terminal device mentioned above. In another possible design, the system may further include other devices that interact with the communication apparatus or the terminal device in the solutions provided by the embodiments of the present application.

In a fourteenth aspect, the embodiments of the present application provide a non-transitory computer-readable storage medium, having a computer program stored thereon, where the computer program enables a computer to perform part or all of the steps of the methods in the various aspects mentioned above.

In a fifteenth aspect, the embodiments of the present application provide a computer program product, where the computer program product includes a non-transitory computer-readable storage medium storing a computer program, and the computer program may be operated to enable a computer to perform part or all of the steps of the methods in the various aspects mentioned above. In some implementations, the computer program product may be a software installation package.

In a sixteenth aspect, the embodiments of the present application provide a computer program, where the computer program may be operated to enable a computer to perform part or all of the steps of the methods in the various aspects mentioned above.

In a seventeenth aspect, the embodiments of the present application provide a chip, which includes a memory and a processor, where the processor may call and run a computer program from the memory, to implement part or all of the steps of the methods in the various aspects mentioned above.

### BRIEF DESCRIPTION OF THE DRAWINGS

FIG. 1 is an example diagram of a system architecture of a wireless communication system to which the embodiments of the present application may be applied.

FIG. 2 is another example diagram of a system architecture of a wireless communication system to which the embodiments of the present application may be applied.

FIG. 3 is an example diagram of an application scenario to which the embodiments of the present application are applicable.

FIG. 4 is another example diagram of an application scenario to which the embodiments of the present application are applicable.

FIG. 5 is yet another example diagram of an application scenario to which the embodiments of the present application are applicable.

FIG. 6 is still another example diagram of an application scenario to which the embodiments of the present application are applicable.

FIG. 7 is a schematic flowchart of a wireless communication method provided by an embodiment of the present application.

FIG. 8 is a schematic flowchart of a wireless communication method provided by another embodiment of the present application.

FIG. 9 is a schematic flowchart of a wireless communication method provided by yet another embodiment of the present application.

FIG. 10 is a schematic flowchart of a wireless communication method provided by yet another embodiment of the present application.

FIG. 11 is a schematic flowchart of a wireless communication method provided by yet another embodiment of the present application.

FIG. 12 is a schematic flowchart of a wireless communication method provided by yet another embodiment of the present application.

FIG. 13 is a schematic structural diagram of a communication apparatus provided by an embodiment of the present application.

FIG. 14 is a schematic structural diagram of a communication apparatus provided by another embodiment of the present application.

FIG. 15 is a schematic structural diagram of a communication apparatus provided by yet another embodiment of the present application.

FIG. 16 is a schematic structural diagram of a communication apparatus provided by yet another embodiment of the present application.

FIG. 17 is a schematic structural diagram of a terminal device provided by an embodiment of the present application.

FIG. 18 is a schematic structural diagram of a communication apparatus provided by yet another embodiment of the present application.

### DETAILED DESCRIPTION

### Communication system architecture

The technical solutions of the embodiments of the present application may be applied to various communication systems, such as, a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, an LTE frequency division duplex (FDD) system, an LTE time division duplex (TDD) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a terrestrial networks (TN) system, a universal mobile telecommunication system (UMTS), wireless local area networks (WLAN), a wireless fidelity (WIFI), or a 5th-Generation (5G) system. The technical solutions provided by the present application may further be applied to other communication systems, such as future communication systems (e.g., a 6th-Generation mobile communication system), or satellite communication systems.

Generally speaking, a number of connections supported by a traditional communication system is limited and is easy to implement, however, with the development of the communication technology, the mobile communication system will not only support the traditional communication, but also support communication such as device to device (D2D) communication, machine to machine (M2M) communication, machine type communication (MTC), vehicle to vehicle (V2V) communication, or vehicle to everything (V2X) communication, and the embodiments of the present application may also be applied to these communication systems.

The communication system in the embodiments of the present application may be applied to a carrier aggregation (CA) scenario, a dual connectivity (DC) scenario, or a standalone (SA) networking scenario.

The communication system in the embodiments of the present application may be applied to an unlicensed spectrum, where the unlicensed spectrum may also be considered as a shared spectrum; or the communication system in the embodiments of the present application may also be applied to a licensed spectrum, where the licensed spectrum may also be considered as a dedicated spectrum.

An important feature of a communication system architecture (e.g., 5G system architecture) is that the communication system architecture may be a service-oriented architecture, that is, network elements (service providers) in the core network may provide a specific service, and the specific service is called by other network elements (consumers) through a defined API interface.

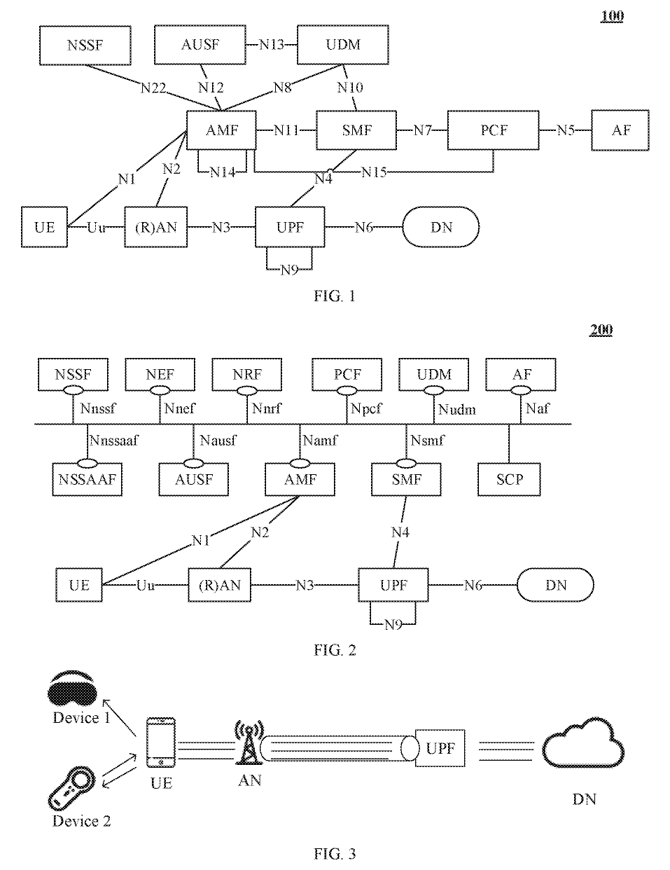

FIG. 1 and FIG. 2 exemplarily illustrate example diagrams of system architectures of wireless communication systems to which the embodiments of the present application may be applied. Taking the communication system as a 5G system architecture as an example, the wireless communication system may include multiple network elements, such as, a terminal device, an access network (AN) device, a UPF network element, an access and mobility management function (AMF) network element, a session management function (SMF) network element, a policy control function (PCF) network element, and an application function (AF) network element. The wireless communication system may also include a DN or the like.

The functions of various parts or network elements involved in the wireless communication system in the 5G network are illustrated below.

Terminal device: the terminal device may also be referred to as a user equipment (UE), an access terminal, a user unit, a user station, a mobile platform, a mobile station (MS), a mobile terminal (MT), a remote station, a remote terminal, a mobile device, a user terminal, a terminal, a wireless communication device, a user agent or a user apparatus. The terminal device in the embodiments of the present application may be a device that provides voice and/or data connectivity to users and may be used to connect human, objects and machines, such as, a handheld device or a vehicle-mounted device with wireless connection functions. The terminal device in the embodiments of the present application may be a mobile phone, a pad, a laptop computer, a personal digital assistant (PDA), a mobile internet device (MID), a wearable device, a vehicle device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like.

Access network device: the access network device can be used to provide network access functions for authorized terminal devices in a specific area, and can use transmission channels with different qualities according to the level, service requirements or the like of the terminal device. The access network device can manage radio resources, provide access services for the terminal device, and then complete the forwarding of control signals and data between the terminal device and the core network.

The access network device may be a device in a wireless network. The access network device may also be referred to as a radio access network (RAN) device or a network device, for example, the access network device may be a base station. The access network device in the embodiments of the present application may refer to a radio access network (RAN) node (or device) that connects a terminal device to a wireless network. The base station may broadly cover the following various names or be replaced with the following names, such as NodeB, evolved NodeB (eNB), next generation NodeB (gNB), relay station, access point, transmitting and receiving point (TRP), transmitting point (TP), master station MeNB, secondary station SeNB, multi-standard radio (MSR) node, home base station, network controller, access node, radio node, access point (AP), transmission node, transceiver node, base band unit (BBU), remote radio unit (RRU), active antenna unit (AAU), remote radio head (RRH), central unit (CU), distributed unit (DU), or positioning node. The base station may be a macro base station, a micro base station, a relay node, a donor node, or the like, or a combination thereof. The base station may also refer to a communication module, a modem or a chip set in the aforementioned devices or apparatuses. The base station may further be a device that performs station functions in a mobile switching center, a device-to-device (D2D), vehicle-to-everything (V2X) or machine-to-machine (M2M) communications, a network side device in a 6G network, or a device that performs base station functions in the future communication systems. The base station may support networks with the same or different access technologies. The technology and device form adopted by the access network device is not limited in the embodiments of the present application.

The base station may be fixed or mobile. For example, a helicopter or drone may be configured to act as a mobile base station, and one or more cells may move according to the location of the mobile base station. In other examples, a helicopter or drone may be configured to function as a device to communicate with another base station.

In some deployments, the access network device in the embodiments of the present application may refer to a CU or a DU, or the access network device includes a CU and a DU. The gNB may further include an AAU.

The access network device and the terminal device may be deployed on land, including indoors or outdoors, handheld or vehicle-mounted; may also be deployed on water surface; and may also be deployed on aircraft in the air, balloons and satellites. The scenarios in which the access network device and the terminal device are located are not limited in the embodiments of the present application.

UPF network element: the UPF is a user plane function in the core network, and is responsible for forwarding and receiving user data (e.g., service data flow) in the terminal device. The UPF may connect to the access network device (e.g., the base station) and external data networks for data transmission. For example, the UPF may receive the user data from the DN and transmit the user data to the terminal device through the access network device. Alternatively, the UPF may also receive the user data from the terminal device through the access network device, and then forward the user data to the DN. The transmission resources and scheduling functions that provide services to the terminal device in UPF are managed and controlled by the SMF. In some embodiments, the UPF may be divided into an intermediate-UPF (I-UPF) and an anchor-UPF (A-UPF). The I-UPF is connected to the access network, A-UPF is the UPF of the session anchor, and A-UPF may also be referred to as a PDU session anchor (PSA).

AMF network element: the AMF is a mobility management function in the core network, and may be used to implement other functions in the functions of the mobility management entity (MME) in addition to the session management, such as lawful monitoring or access license (or authentication). In some embodiments, in addition to performing mobility management on the terminal device, the AMF may also be responsible for forwarding session management related messages between the terminal device and the SMF.

SMF network element: the SMF is a session management function in the core network, and is mainly responsible for session management, Internet protocol (IP) address allocation and management of the terminal device, selection of manageable user plane functions, serving as the endpoints for policy control or charging function interfaces, downlink data notification, configuration routing information for user plane functions or the like.

PCF network element: the PCF is a policy management function in the core network, and is responsible for formulating policies related to mobility management, session management, charging or the like for the terminal device. For example, the PCF may provide policy rule information or the like for the functional network element of the control plane (e.g., AMF, SMF network elements), to manage and control the mobility management, session management or the like of the terminal device.

AF network element: the AF mainly supports interaction with 3rd generation partnership project (3GPP) core network to provide services, such as influencing data routing decisions, policy control functions, or providing some third-party services to the network side. In other words, the AF may be mainly used to convey requirements of the application side to the network side. In some embodiments, the AF may be an operator-internal application, such as IP multimedia subsystem (IMS) technology. In some embodiments, the AF may be understood as a third-party server, e.g., an application server in the Internet, which provides relevant service information, including providing quality of service (QoS) requirement information corresponding to the service to the PCF and transmitting user plane data information of the service to the A-UPF. In some embodiments, the AF may also be a content provider (CP). In some embodiments, if the AF is an operator-internal AF and is in a trusted domain with other network functions (NFs), the AF may directly interact and access with other NFs; and if the AF is not in a trusted domain, the AF needs to access other NFs through other network elements (e.g., the NEF network element hereinafter).

DN: the DN refers to a network that may be used to provide data transmission. The DN may be a private network, e.g., a local area network, or an external network that is not controlled by the operator, e.g., the Internet, or may also be a dedicated network jointly deployed by operators, e.g., a network that provides IMS services.

It is to be understood that the above various network elements in the core network may also be referred to as functional entities, and the present application does not limit thereto. For example, the UPF network element may also be referred to as a UPF entity, the AMF network element may also be referred to as an AMF entity, or the like. It is also to be understood that in some embodiments, a xx network element or xx functional entity may also be simply referred to as xx, for example, the UPF network element (or UPF entity) may be simply referred to as UPF, and the AMF network element (or AMF entity) may be simply referred to as AMF. For the sake of convenience of description, the xx (e.g., UPF, AMF) mentioned in the embodiments of the present application may refer to xx network element or xx entity, which will not be repeated hereinafter.

Optionally, the wireless communication system may further include a unified data management (UDM) network element, an authentication server function (AUSF) network element, a network slice selection function (NSSF) network element, a network exposure function (NEF) network element, a network data analysis function (NWDAF) network element, and other network elements, and the embodiments of the present application are not limited thereto.

The UDM network element is a subscription database in the core network, and may be used to generate and store subscription data of user in the network (e.g., 5G network), manage authentication data and perform other functions. The UDM network element may support interaction with external third-party servers. The AUSF network element may be used to receive an identity authentication request from the AMF for the terminal device, by requesting a key from the UDM and then forwarding the delivered key to the AMF for authentication processing. The NSSF network element may be used for network slice selection. The NEF network element may be responsible for managing the exposure of the network data from the 5G network element to external parties, and external non-trusted applications need to access the internal data of the core network through the NEF to ensure the security of the 3GPP network. In some embodiments, the NEF network element may also provide functions such as external application QoS capability exposure, event subscription, and AF request distribution. The NWDAF network element may collect data from various network elements and network management systems or the like in the core network to perform big data statistics, analysis, or intelligent data analysis, to obtain network-side analysis results or network-side prediction data, thereby assisting various network elements to more effectively control the terminal device according to the data analysis results.

In the wireless communication systems illustrated in FIG. 1 and FIG. 2, various parts or network elements may communicate with each other through an interface. For example, the terminal device may perform an access stratum connection with the AN through a Uu interface to exchange access stratum messages and wireless data transmission; the terminal device may perform a non access stratum (NAS) connection with the AMF through an N1 interface to exchange NAS messages; the AN may connect to the AMF through an N2 interface to transmit radio bearer control information from the core network side to the AN; and the UPF may perform data transmission with the AN through an N3 interface, and perform data transmission with the DN through an N6 interface or the like. The interfaces for connecting other parts or network elements may be found in FIG. 1 and FIG.2, and will not be repeated here.

It is to be understood that the network elements such as the terminal device, access network device, SMF, PCF illustrated in FIG. 1 and FIG.2 are only names, and the names do not limit the devices themselves. In the 5G network and other future networks, the network elements corresponding to the terminal device, access network device, SMF, PCF or the like may also have other names, and the embodiments of the present application do not specifically limit these names.

It is to be understood that the above communication system is illustrated using the 5G system as an example. Of course, the present application may also be applied to other 3GPP communication systems, such as the 4G communication system, or future 3GPP communication systems, and the embodiments of the present application are not limited thereto.

It is to be understood that all or part of the functions of the communication device in the present application may also be implemented through software functions running on hardware, or through virtualization functions instantiated on a platform (e.g., a cloud platform).

It is to be understood that the system architecture described in the embodiments of the present application is intended to more clearly describe the technical solutions of the embodiments of the present application, and does not constitute a limitation on the technical solutions provided by the embodiments of the present application. Those skilled in the art would know that the embodiments of the present application may also be applicable to similar technical problems with the evolution of the network architecture.

### QoS monitoring

In order to assist ultra reliable & low latency communication (URLLC) services, some communication systems (e.g., NR systems) have introduced a QoS monitoring mechanism. QoS monitoring is mainly used to measure a packet delay. For example, QoS monitoring may be used to measure a packet delay between a terminal device and an anchor UPF.

In some embodiments, the definition of the packet delay between the terminal device and the anchor UPF may be found in the introduction of Section TS38.314 of the 3GPP specification. As an implementation, the packet delay between the terminal device and the anchor UPF may be composed of two parts, namely an uplink and downlink packet delay between the terminal device and an access network device, and an uplink and downlink packet delay between the access network device and the anchor UPF.

In some protocols (e.g., 3GPP protocol R18), QoS monitoring may be used to monitor parameters such as congestion information in addition to monitoring packet delay. As an implementation, the AF may trigger QoS monitoring for a service data flow (SDF), mainly including the following measured QoS parameters: an uplink/downlink packet delay, a round-trip packet delay; congestion information; data transmission rate; packet delay variation; round-trip times (or round-trip delays) corresponding to mapping of uplink and downlink data flows onto different QoS flows or the like.

A QoS monitoring policy corresponding to the QoS monitoring may be generated by the PCF. For example, the PCF may generate the QoS monitoring policy based on a request from a third-party server. As an implementation, if the PCF receives a QoS monitoring request from the AF, the PCF may generate an authorized QoS monitoring policy according to the service data flow. In some embodiments, after generating the QoS monitoring policy, the PCF may include the authorized QoS monitoring policy in a policy and charging control (PCC) rule, and provide it to the SMF.

In some embodiments, the access network device needs to provide QoS monitoring for the uplink and downlink packet delay between the terminal device and the access network device. In other words, QoS monitoring is performed on the uplink and downlink packet delay between the terminal device and the access network by the access network device.

In some embodiments, QoS monitoring for the uplink and downlink packet delay between the access network device and the anchor UPF may be performed at different granularities (levels). For example, QoS monitoring for the uplink and downlink packet delay between the access network device and the anchor UPF may include QoS monitoring of each QoS flow level of each terminal device and/or QoS monitoring of each general packet radio service tunnelling protocol-user plane (GTP-U) path level. In some embodiments, the granularity of QoS monitoring used for the uplink and downlink packet delay between the access network device and the anchor UPF is determined based on one or more of the following factors: operator configuration, requests from the third-party application, or PCF policy control of the URLLC service.

QoS monitoring at different granularities is introduced below.

QoS monitoring of each QoS flow level of each terminal device

In some embodiments, the SMF may activate end-to-end uplink and downlink packet delay measurement between the terminal device and the anchor UPF for a QoS flow. For example, the SMF may activate the end-to-end uplink and downlink packet delay measurement between the terminal device and the anchor UPF for a QoS flow during a PDU session establishment or modification process.

As an implementation, the SMF may transmit a QoS monitoring request message to the anchor UPF and the access network device, respectively, to initiate QoS monitoring between the anchor UPF and the terminal device. In some embodiments, the SMF may transmit a QoS monitoring request message to the anchor UPF via the N4 interface, and/or transmit a QoS monitoring request message to the access network device via N2 signaling.

The QoS monitoring request message transmitted by the SMF may carry one or more monitoring parameters. The one or more monitoring parameters may be obtained by the SMF based on the QoS monitoring policy of the PCF or based on local configuration.

In some embodiments, after receiving the QoS monitoring request message from the SMF, the access network device may initiate measurement for the uplink and downlink packet delay of the access network part (i.e., the uplink and downlink packet delay between the terminal device and the access network device), and report the measurement result to the anchor UPF through an uplink data packet.

If the access network device and the anchor UPF are synchronized in time, monitoring for a one-way packet delay between the access network device and the anchor UPF is allowed. In some embodiments, if the access network device and the anchor UPF are not synchronized in time, the communication system may assume that the uplink packet delay and the downlink packet delay between the access network device and the anchor UPF are the same when performing packet delay monitoring.

In both above cases, the anchor UPF will create a monitoring package and transmit the monitoring package to the access network device at a certain measurement frequency. As an implementation, the measurement frequency of transmitting the monitoring packet by the anchor UPF may be determined by the anchor UPF according to the QoS monitoring report frequency received from the SMF.

A process example of the QoS monitoring of each QoS flow level of each terminal device is introduced below.

Step I: the anchor UPF encapsulates a QoS flow identifier (QFI), QoS monitoring packet indication information and local time (e.g., T1) into a GPT-U packet header. As an implementation, the QoS monitoring packet indication information is used to indicate that the data packet is used for uplink and downlink packet delay measurement. In some embodiments, the local time (T1) may refer to a time when the anchor UPF transmits a downlink monitoring packet.

Step II: the access network device receives the downlink monitoring packet transmitted by the anchor UPF, and records the local time (T1) in the received GTP-U packet header and a time when the downlink monitoring packet is received (e.g., T2).

Step III: the access network device transmits a monitoring response packet to the UPF. In some embodiments, the access network device may transmit the monitoring response packet to the UPF via the N3 interface.

In some embodiments, a GTP-U header of the monitoring response packet may carry one or more of: QoS monitoring packet indication information, a packet delay measurement result of the access network part, the local time (T1) in the GTP-U header received by the access network, the time (T2) when the access network device receives the downlink monitoring packet, or a time (e.g., T3) when the access network device transmits the monitoring response packet.

In some embodiments, the access network device transmitting the monitoring response packet is triggered based on one or more of: that the access network device receives an uplink data packet corresponding to the QFI (QFI carried in the GTP-U transmitted by the anchor UPF) from the terminal device, or that the access network device transmits a virtual uplink data packet as a monitoring response. In some embodiments, a timing for the access network device to transmit a virtual uplink data packet as the monitoring in response to the anchor UPF depends on the implementation of the access network device.

Step IV: the anchor UPF determines the round-trip time or the uplink and downlink packet delay between the access network device and the anchor UPF. For example, if the access network device and the anchor UPF are not synchronized in time, the anchor UPF may determine the round-trip time between the access network device and the anchor UPF; and if the access network device and the anchor UPF are synchronized in time, the anchor UPF may determine the uplink and downlink packet delay between the access network device and the anchor UPF.

In some embodiments, the anchor UPF may determine the round-trip time or uplink and downlink packet delay between the access network device and the anchor UPF based on one or more of following pieces of information: a local time (e.g., T4) when the anchor UPF receives the monitoring response packet, or time information included in the GTP-U packet header of the monitoring response packet.

As an implementation, if the access network device and the anchor UPF are not synchronized in time, the anchor UPF may obtain the packet delay between the anchor UPF and the access network device by calculating (T2-T1+T4-T3)/2. As another implementation, if the access network device and the anchor UPF are synchronized in time, the anchor UPF may obtain the uplink packet delay by calculating (T4-T3), and obtain the downlink packet delay by calculating (T2-T1).

In some embodiments, further, the anchor UPF may determine the uplink and downlink packet delay between the anchor UPF and the terminal device based on the received uplink and downlink delay result of the access network part and the calculated uplink and downlink packet delay between the access network device and the anchor UPF.

In some embodiments, the anchor UPF may report the above calculation result to the SMF. For example, when certain specific conditions (e.g., reaching a reporting threshold or a reporting period) are met, the anchor UPF may report the calculation result to the SMF.

It is to be understood that if the access network device and the anchor UPF are not synchronized in time, the calculation result of the uplink and downlink packet delay may be inaccurate.

In some embodiments, if redundant transmission on the N3/N9 interface is activated, the UPF and the access network device may perform QoS monitoring on the two user plane paths, respectively. In this case, the UPF may report the packet delays of the two user plane paths to the SMF, respectively.

### QoS monitoring of GTP-U path level

In some embodiments, the SMF may request activation of QoS monitoring for all GTP-U paths between the access network device and all UPFs. In some embodiments, the activation is triggered based on a policy of the local configuration of the SMF. In some embodiments, when the SMF receives the QoS monitoring policy in a PCC rule, and QoS monitoring for the differential services code point corresponding to the 5G QoS identifier (5QI) in the PCC rule has not been activated, the SMF may activate QoS monitoring for all UPFs and access network devices for the current PDU session. In this case, the SMF does not consider the QoS monitoring policy in the PCC rule when performing QoS flow binding. The QoS monitoring policy in the PCC rule is used to trigger the SMF to indicate the UPF to initiate GTP-U-based QoS monitoring. The SMF may transmit the QoS monitoring policy to each involved UPF and access network device through the N4 interface and the N2 interface, respectively.

A GTP-U transmitter may estimate the round-trip time (RTT) between the GTP-U transmitter and a receiver on the GTP-U path by transmitting an Echo message and measuring the time elapsed between transmitting a request message and receiving a response message.

The GTP-U transmitter may calculate the current accumulated packet delay by adding (summing) the following information: RTT/2 between the GTP-U transmitter and the receiver on the GTP-U path, processing time of the GTP-U transmitter, and an accumulated packet delay from an upstream GTP-U transmitter (i.e., an immediately previous GTP-U transmitter in the user plane path). In some embodiments, the current accumulated packet delay measured by the GTP-U transmitter may be used to estimate the time elapsed since the user plane data packet entered the 3GPP domain.

In some embodiments, the GTP-U transmitter may periodically determine the round-trip time to monitor changes in transmission delay.

As an implementation, QoS monitoring may be performed by the GTP-U endpoint (user plane function). The endpoint may receive and store the QoS monitoring policies, including a QoS flow packet delay budget (PDB) parameter. In some embodiments, the GTP-U transmitter may compare the measured accumulated packet delay with stored QoS parameter (e.g., PDB parameter) to perform QoS monitoring.

If the GTP-U endpoint (e.g., the anchor UPF) determines that the packet delay exceeds a requested PDB in a case of reporting the accumulated packet delay, the GTP-U endpoint may trigger QoS monitoring alarm signaling to the relevant SMF or operations, administration and maintenance (OA&M). QoS monitoring may be used to measure the packet delay of the transmission path and map the QoS flow to an appropriate network instance.

In QoS monitoring of GTP-U path level, packet delay measurement may be performed in the corresponding user plane transmission path by using the GTP-U Echo request and response defined in 3GPP specification TS 28.552. The packet delay measurement may be used for a specific URLLC service, regardless of the corresponding PDU session and 5QI for a given QoS flow.

A process example of the QoS monitoring of GTP-U path level is introduced below.

Step I: the access network device measures the packet delay of the access network part (the packet delay between the access network device and the terminal device), and provides the measurement result to the UPF. For example, the access network device provides the measurement result to the UPF via the N3 interface.

Step II: the UPF determines the uplink and downlink packet delay.

Step III: the UPF reports the QoS monitoring result to the SMF. For example, the UPF may report the QoS monitoring result to the SMF when certain specific conditions are met. The embodiments of the present application do not limit such specific conditions. For example, such specific conditions may be associated with one or more of: that the UPF obtains the QoS monitoring result for the first time, that the QoS monitoring result is periodically reported, that reporting the QoS monitoring result is triggered by an event, the QoS monitoring result is reported when a threshold for reporting to the SMF is reached, or the like.

In some embodiments, the UPF may support notifying the AF of the QoS monitoring result via the local NEF.

Step IV: the UPF measures a network hop delay of each transmission resource. As an implementation, the UPF may calculate the network hop delay by transmitting an Echo request on the transmission resource and measuring RTT/2 when receiving an Echo response. The RTT refers to the RTT between the UPF transmitting the Echo request and receiving the Echo response.

Step V: the UPF maps {network instance, differential service code point} to the transmission resource, and measures a delay of each target IP address and port.

Step VI: the UPF performing QoS monitoring provides the SMF with the corresponding {network instance, differential service code point}, and a measured accumulated packet delay of the corresponding transmission path.

Step VII: the SMF maps a QoS flow to an appropriate {network instance, differential service code point}. As an implementation, the SMF may map the QoS flow to the appropriate {network instance, differential service code point} based on a parameter set of a given QoS flow. The QoS parameter set may include, for example, one or more of: a 5QI of the QoS flow, QoS characteristics of the QoS flow, or allocation and retention priority (ARP) corresponding to the QoS flow. As an example, the SMF may map the QoS flow to the appropriate {network instance, differential service code point} based on {5QI, QoS characteristics, ARP} of the given QoS flow.

As mentioned above, in order to optimize the performance of the communication system (such as auxiliary URLLC services), some communication systems have introduced a QoS monitoring mechanism. However, the current QoS monitoring mechanism can only be used to measure the packet delay between the terminal device and the UPF, the RTT between the terminal device and the UPF, or the like. With the increase of services scenarios in the communication systems, the demand for end-to-end QoS control of services has become more and more abundant, and the current QoS monitoring mechanism may not be able to meet the demand. Therefore, how to enhance the QoS monitoring mechanism is an urgent problem to be solved.

To address the above problems, the embodiments of the present application provide a wireless communication method and a communication apparatus, to achieve the end-to-end QoS control between the DN/UPF and an associated device of a terminal device by supplementing a packet delay measurement mechanism, thereby enhancing the QoS monitoring mechanism.

To facilitate understanding, application scenarios (services scenarios) to which the embodiments of the present application are applicable are first introduced below.

In some embodiments, the embodiments of the present application may be applicable to a scenario where there is an associated device of a terminal device in a communication system. In other words, the embodiments of the present application may be applicable to a scenario where there is a requirement to measure a packet delay between the associated device of the terminal device and other nodes/devices.

As an example, the embodiments of the present application may be applicable to a scenario of packet delay measurement between the associated device of the terminal device and the terminal device. As another example, the embodiments of the present application may be applicable to a scenario of packet delay measurement between the associated device of the terminal device and a UPF/DN. As yet another example, the embodiments of the present application may be applicable to a scenario of packet delay measurement between multiple associated devices of the terminal device.

It is to be understood that in the embodiments of the present application, the associated device of the terminal device refers to other devices associated with the terminal device. In some embodiments, the associated device of the terminal device may refer to that the associated device is a device that communicates with a mobile communication network (e.g., 5GC) through the terminal device. In some embodiments, the associated device of the terminal device may refer to that the associated device is a device attached to the terminal device, e.g., some wearable devices (VR devices, AR devices, etc.) attached to the terminal device. In some embodiments, the associated device of the terminal device may refer to that the associated device is a device that uses the terminal device as a gateway or relay, that is, the associated device may access the mobile communication network through the relay or bridge of the terminal device. For example, when the terminal device is used as a customer premise equipment (CPE), a device that access the network through the terminal device may be referred to as the associated device of the terminal device.

In some embodiments, the associated device of the terminal device may be a 3GPP terminal device, e.g., a 3GPP wearable device. In some embodiments, the associated device of the terminal device may be a non-3GPP device, which is not limited in the embodiments of the present application.

The name of the associated device of the terminal device is not limited in the embodiments of the present application. For example, the associated device of the terminal device may also be referred to as or understood as an attached device of the terminal device, device behind UE, tethered device, or the like.

In some embodiments, the embodiments of the present application may be applicable to a scenario where there is a requirement to measure a packet delay between the UPF and the DN (or referred to as N6 delay, where the packet delay between the UPF and the DN mentioned hereinafter may be replaced by N6 delay). As an example, the embodiments of the present application may be applied to a scenario of packet delay measurement between the UPF and the DN. As another example, the embodiments of the present application may be applicable to a scenario of packet delay measurements between different associated devices of the terminal device (or referred to as different associated devices, where the different associated devices of the terminal device mentioned hereinafter may be understood as or replaced by different associated devices), forwarded via the UPF/DN. As yet another example, the embodiments of the present application may be applicable to a scenario of packet delay measurement between the associated device of the terminal device and the terminal device, forwarded via the UPF/DN.

In some embodiments, different associated devices of the terminal device may be associated with or attached to the same terminal device. In some embodiments, different associated devices of the terminal device may be associated with or attached to different terminal devices, which is not limited in the embodiments of the present application. Taking an example that the different associated devices of the terminal device include a first associated device and a second associated device, the first associated device and the second associated device may both be associated with or attached to a first terminal device; or the first associated device may be associated with or attached to the first terminal device, and the second associated device may be associated with or attached to a second terminal device.

Several application scenarios to which the embodiments of the present application are applicable are exemplarily introduced below in conjunction with FIG. 3 to FIG. 6.

FIG. 3 illustrates a scenario of end-to-end packet delay monitoring. As illustrated in FIG. 3, in the scenario of packet delay monitoring, the communication system includes multiple network entities, such as associated devices of a terminal device, the terminal device, an access network device, a UPF, and a DN, or the like. In the example of FIG. 3, device 1 and device 2 are the associated devices of the terminal device, device 1 and device 2 may be 3GPP terminal devices or non-3GPP devices. FIG. 3 exemplarily illustrates two associated devices of the terminal device, but the embodiments of the present application are not limited thereto. The embodiments of the present application may also be applied to a scenario of one associated devices of the terminal device or more than two associated devices of the terminal device.

The end-to-end service illustrated in FIG. 3 may include different services, for example, include end-to-end services between the associated devices of the terminal device and the DN, end-to-end services between different associated devices of the terminal device, and end-to-end services with asymmetric uplink and downlink.

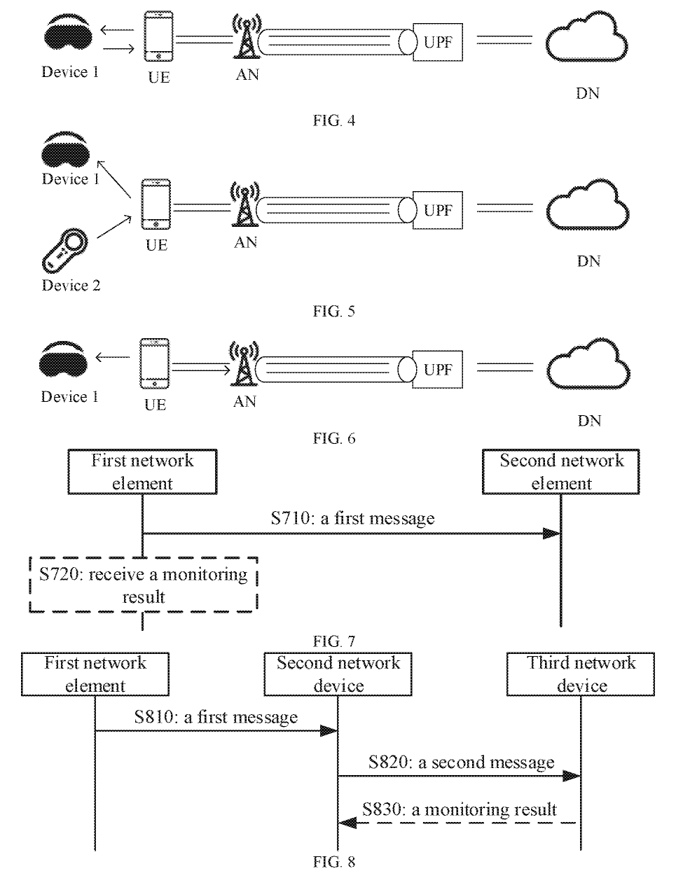

FIG. 4 illustrates an example of an end-to-end service between the associated device of the terminal device and the DN. In an example of FIG. 4, device 1 is an associated device of the terminal device. As illustrated in FIG. 4, the end-to-end service between the associated device of the terminal device and the DN may include uplink service and/or downlink service. The downlink service between the associated device of the terminal device and the DN may be expressed as: DN → anchor UPF (PSA UPF) → I-UPF → access network device → terminal device → associated device of the terminal device (device 1). The uplink service between the associated device of the terminal device and the DN may be expressed as: associated device of the terminal device (device 1) → terminal device → access network device → I-UPF → anchor point UPF → DN.

FIG. 5 illustrates an example of end-to-end services between different associated devices of the terminal device. In an example of FIG. 5, device 1 and device 2 are associated devices of the terminal device. As illustrated in FIG. 5, the end-to-end services between the different associated devices of the terminal device (i.e., device 1 and device 2) may include one or more of the following services: device 1 - terminal device - device 2; device 1 - terminal device - access network device – UPF - access network device - terminal device - device 2; device 1 - terminal device - access network device - UPF - UPF -access network device - terminal device - device 2; or device 1 - terminal device - access network device - UPF - DN - UPF - access network device - terminal device - device 2.

It is to be understood that when device 1 and device 2 correspond to the same UPF, or when device 1 and device 2 are served by the same UPF, the end-to-end service between device 1 and device 2 forwarded via UPF may be expressed as: device 1 - terminal device - access network device - UPF - access network device - terminal device - device 2. When device 1 and device 2 correspond to different UPFs, or in other words, when device 1 and device 2 are served by different UPFs, the end-to-end service between device 1 and device 2 forwarded via UPF may be expressed as: device 1 - terminal device - access network device - UPF - UPF - access network device - terminal device - device 2.

FIG. 6 illustrates an example of an end-to-end service with asymmetric uplink and downlink. In an example of FIG. 6, device 1 is an associated device of the terminal device. As illustrated in FIG. 6, the end-to-end service with asymmetric uplink and downlink may refer to an end-to-end service between the terminal device and the associated device (device 1) of the terminal device. In some embodiments, the end-to-end service between the terminal device and the associated device of the terminal device may include: an uplink service between the terminal device and the UPF/DN, and a downlink service between the associated device of the terminal device and the UPF/DN. In some embodiments, the end-to-end service between the terminal device and the associated device of the terminal device may include: a downlink service between the terminal device and the UPF/DN, and an uplink service between the associated device of the terminal device and the UPF/DN.

As an example, in an example of FIG. 6, the asymmetric end-to-end services may be expressed as: the downlink service (DN → anchor UPF → I-UPF → access network device → terminal device →associated device of the terminal device), and the uplink service (terminal device → access network device → I-UPF → anchor UPF → DN). As another example, in an example of FIG. 6, the asymmetric end-to-end services may be expressed as: the downlink services (DN → anchor UPF →I-UPF → access network device →terminal device), and the uplink service (associated device of the terminal device →terminal device → access network device → I-UPF → anchor UPF →DN).

In some embodiments, the associated device of the terminal device, the terminal device, the access network device and the UPF in the uplink service and downlink service mentioned above may be the same network entity. In some embodiments, the associated device of the terminal device, the terminal device, the access network device and the UPF in the uplink service and downlink service mentioned above may be different network entities, and the embodiments of the present application do not limit thereto. For example, the associated device of the terminal device in the downlink service and the associated device of the terminal device in the uplink service are the same network entity (e.g., both are device 1 illustrated in FIG. 3). Alternatively, the associated device of the terminal device in the downlink service and the associated device of the terminal device in the uplink service are different network entities (e.g., the associated device of the terminal device in the downlink service is device 1 illustrated in FIG. 3, and the associated device of the terminal device in the uplink service is device 2 illustrated in FIG. 3). Whether other nodes or devices (e.g., terminal devices, access network devices, and UPFs) are the same network entities in downlink and uplink services is similar to the above description of the associated devices of the terminal device, which will not be repeated here for the sake of brevity.

The number of I-UPFs included between the access network device and the anchor UPF is not limited in the embodiments of the present application. For example, there may be 0 or more I-UPFs between the access network device and the anchor UPF.

The method embodiments of the present application are described below in conjunction with the accompanying drawings. FIG. 7 is a flowchart of a wireless communication method provided by an embodiment of the present application. The method illustrated in FIG. 7 is introduced from the perspective of interaction between a first network element and a second network element. To facilitate understanding, the first network element and the second network element are introduced first.

In the embodiments of the present application, the first network element is a network element that initiates a QoS monitoring request; or in other words, the first network element is a network element that requests QoS monitoring. For example, the first network element is a network element that requests QoS monitoring for a packet delay.

The first network element is not limited specifically in the embodiments of the present application as long as the first network element can initiate the QoS monitoring request (e.g., a QoS monitoring request for a packet delay). Several possible implementation forms of the first network element are introduced below as examples.

In some embodiments, the first network element may be a third-party server or a third-party application; or in other words, the first network element may be a network element used to convey requirements of the application side to the network side. Taking the NR system as an example, the first network element may be an AF. However, the present application is not limited thereto. The first network element may be other third-party servers or third-party applications, or in other words, the first network element may be other network elements, nodes or devices used to convey requirements of the application side to the network side. For example, the first network element may be a third-party server or a third-party application in the future communication systems. Alternatively, the first network element may be a network element in the future communication systems used to convey requirements of the application side to the network side, or the like.

In some embodiments, the first network element may be a network element in a core network. That is, the first network element may be a network element in the core network that can initiate the QoS monitoring request. Taking the NR system as an example, the first network element may be the SMF, PCF or the like in the core network. Taking the LTE system as an example, the first network element may be a mobility management entity (MME), a policy and charging rules function (PCRF) or the like in the core network. Certainly, the first network element may further be a network element in a core network in the future communication systems, which is not limited in the embodiments of the present application.

In some embodiments, the first network element may be a terminal device. That is, the terminal device may initiate the QoS monitoring request, for example, initiate the QoS monitoring request for the packet delay.

In addition to the possible implementation forms of the first network element listed above, the first network element may further be other network elements, nodes or devices, which is not limited in the embodiments of the present application. For example, the first network element may further be an access network device, that is, the access network device may also initiate the QoS monitoring request to the second network element.

In the embodiments of the present application, the second network element may receive the QoS monitoring request transmitted by the first network element. In some embodiments, the second network element may generate a corresponding QoS monitoring policy for the QoS monitoring request. In other words, in some embodiments, the second network element may provide policy rule information to other network elements, nodes or devices in the core network. In some embodiments, the second network element may be a network element in the core network.

For example, taking the NR system as an example, the second network element may be a PCF in the core network. However, the embodiments of the present application are not limited thereto. The second network element may further be other network elements, nodes or devices that can generate the corresponding QoS monitoring policy for the QoS monitoring request. In other words, the second network element may further be other network elements, nodes or devices that can provide the policy rule information for network elements, nodes or devices in the core network. For example, the second network element may be a network element, a node or a device in the future communication systems that can generate the corresponding QoS monitoring policy for the QoS monitoring request.

The method illustrated in FIG. 7 may include step S710, and the step S710 is described below.

In step S710: a first network element transmits a first message to a second network element, where the first message is used to request QoS monitoring for a first packet delay.

In some embodiments, the first packet delay may be related to an associated device of a terminal device, or the first packet delay may include a packet delay related to the associated device of the terminal device. For example, the first packet delay may be related to a packet delay between the terminal device and the associated device of the terminal device, or the first packet delay may include the packet delay between the terminal device and the associated device of the terminal device. Taking the terminal device being a first terminal device as an example, the first packet delay may include a packet delay between the first terminal device and an associated device of the first terminal device.

In some embodiments, the first packet delay may be related to a packet delay between a UPF and a DN, or the first packet delay may be a packet delay related to the packet delay between the UPF and the DN. For example, the first packet delay may include the packet delay between the UPF and the DN.

In some embodiments, the first packet delay may be both related to the packet delay related to the associated device of the terminal device and the packet delay between the UPF and the DN. For example, the first packet delay may include the packet delay between the terminal device and the associated device of the terminal device and the packet delay between the UPF and the DN.

In some embodiments, the first packet delay may include one or more of the following packet delays: a packet delay between the DN and the associated device of the terminal device; a packet delay between the UPF and the associated device of the terminal device; a packet delay between a terminal device and an associated device of a terminal device; a packet delay between the UPF and the DN; a packet delay between different associated devices of the terminal device, forwarded via the UPF; a packet delay between different associated devices of the terminal device, forwarded via the DN; a packet delay between a terminal device and an associated device of a terminal device, forwarded via the UPF; a packet delay between a terminal device and an associated device of a terminal device, forwarded via the DN, or the like.

In some embodiments, different associated devices of the terminal device may be associated with or attached to the same terminal device. Taking an example that the different associated devices of the terminal device include a first associated device and a second associated device, both the first associated device and the second associated device may be associated with or attached to the first terminal device. In this case, the packet delay between different associated devices of the terminal device, forwarded via the UPF/DN may refer to a packet delay between the first associated device of the first terminal device and the second associated device of the first terminal device, forwarded via the UPF/DN.

In some embodiments, the different associated devices of the terminal device may be associated with or attached to different terminal devices. Taking an example that the different associated devices of the terminal device include a first associated device and a second associated device, the first associated device may be associated with or attached to the first terminal device, and the second associated device may be associated with or attached to a second terminal device. In this case, the packet delay between the different associated devices of the terminal device forwarded via the UPF/DN may refer to a packet delay between the first associated device of the first terminal device and the second associated device of the second terminal device, forwarded via the UPF/DN.

In some embodiments, the packet delay between a terminal device and an associated device of a terminal device, forwarded via the UPF/DN, may refer to a packet delay between a terminal device and an associated device of the terminal device, forwarded via the UPF/DN. Taking the terminal device as a first terminal device as an example, the packet delay between a terminal device and an associated device of a terminal device, forwarded via the UPF/DN, may refer to the packet delay between the first terminal device and the associated device of the first terminal device, forwarded via the UPF/DN.

In some embodiments, the packet delay between a terminal device and an associated device of a terminal device, forwarded via the UPF/DN, may refer to a packet delay between a terminal device and an associated device of a terminal device other than the terminal device, forwarded via the UPF/DN. Taking the terminal device including the first terminal device and the second terminal device as an example, the packet delay between a terminal device and an associated device of a terminal device, forwarded via the UPF/DN, may refer to a packet delay between the first terminal device and an associated device of the second terminal device, forwarded via the UPF/DN, or may refer to a packet delay between the second terminal device and an associated device of the first terminal device, forwarded via the UPF/DN.

For example, the first packet delay may be one of the following packet delays: a packet delay between the DN and the associated device of the first terminal device; a packet delay between the UPF and the associated device of the first terminal device; a packet delay between the first terminal device and the associated device of the first terminal device; a packet delay between the UPF and the DN; a packet delay between the first associated device of the first terminal device and the second associated device, forwarded via the UPF; a packet delay between the first associated device of the first terminal device and the second associated device, forwarded via the DN; a packet delay between the first terminal device and the associated device of the first terminal device, forwarded via the UPF; a packet delay between the first terminal device and the associated device of the first terminal device, forwarded via the DN; a packet delay between the second terminal device and the associated device of the first terminal device, forwarded via the UPF; or a packet delay between the second terminal device and the associated device of the first terminal device, forwarded via the DN.

It is to be noted that the above second associated device may be the associated device of the first terminal device, or the second associated device may be an associated device of the second terminal device.

In some embodiments, in addition to the packet delays listed above (that is, in addition to the packet delay related to the associated device of the terminal device and/or the packet delay related to the packet delay between the UPF and the DN), the first packet delay may include other packet delays, which is not limited in the embodiments of the present application. For example, the first packet delay may further include one or more of the following packet delays: a packet delay of an access network part (a packet delay between the access network device and the terminal device), a packet delay between the access network device and the UPF, or the like.

A network element, node or device that measures the first packet delay is not limited in the embodiments of the present application. For example, the measurement of the first packet delay may be performed by one or more of the following network elements, nodes or devices: a terminal device, an access network device, or a network element in a core network. For example, the measurement of the first packet delay may be performed by one or more of the terminal device, the access network device or an element of a user plane network (e.g., a UPF) in the core network.

As an example, the packet delay between a terminal device and an associated device of a terminal device may be measured by a terminal device.

As another example, the packet delay between the terminal device and the access network device may be measured by the access network device.

As yet another example, the packet delay between the access network device and the UPF may be measured by the UPF.

As still another example, the packet delay between the UPF and the DN may be measured by the UPF.

As still another example, the packet delay between the DN/UPF and the associated device of the terminal device may be jointly measured by the terminal device, the access network device and the UPF. Taking the packet delay between the DN and the associated device of the terminal device as an example, the packet delay between the DN and the UPF and the packet delay between the UPF and the access network device may be measured by the UPF; the packet delay between the access network device and the terminal device may be measured by the access network device; and the packet delay between the terminal device and the associated device of the terminal device may be measured by the terminal device.

As still another example, the packet delay between different associated devices of the terminal device, forwarded via the UPF/DN, may be jointly measured by the terminal device, the access network device and the UPF. Taking the packet delay between different associated devices (the first associated device and the second associated device) of the terminal device, forwarded via the DN, as an example, the packet delay between the DN and the UPF, and the packet delay between the UPF and the access network device may be measured by the UPF; the packet delay between the access network device and the terminal device may be measured by the access network device; and the packet delay between the terminal device and the first associated device and the packet delay between the terminal device and the second associated device may be measured by the terminal device. In some embodiments, if the first associated device and the second associated device are associated with or attached to the same terminal device, the packet delay between the terminal device and the first associated device and the packet delay between the terminal device and the second associated device may be measured by the same terminal device. In some embodiments, if the first associated device and the second associated device are associated with or attached to different terminal devices, the packet delay between the terminal device and the first associated device and the packet delay between the terminal device and the second associated device may be measured by different terminal devices.

As still another example, the packet delay between the terminal device and the associated device of the terminal device, forwarded via the UPF/DN, may be jointly measured by the terminal device, the access network device and the UPF. Taking the packet delay between the terminal device and the associated device of the terminal device, forwarded via the DN, as an example, the packet delay between the DN and the UPF and the packet delay between the UPF and the access network device may be measured by the UPF; the packet delay between the access network device and the terminal device may be measured by the access network device; and the packet delay between the terminal device and the associated device of the terminal device may be measured by the terminal device.

In some embodiments, after completing the measurement for the first packet delay, the network element, node or device (e.g., the terminal device, the access network device or the network element in the core network) that measures the first packet delay may report a monitoring result (or referred to as a measurement result) to a target network element (or referred to as a network entity). For example, the network element, node or device that measures the first packet delay may report the monitoring result to the target network entity according to a local configuration or indication information in the QoS monitoring request. This will be described in detail hereinafter, which will not be repeated here for the sake of brevity.

In some embodiments, the first network element may transmit the first message to the second network element one or more times, or the first network element may request QoS monitoring for the first packet delay one or more times. That is, in the embodiments of the present application, the first network element may request the second network element to initiate the measurement of the first packet delay one or more times. For example, the first network element may request the second network element to initiate the measurement of the first packet delay multiple times to obtain the changing situation of the first packet delay, so as to learn whether jitter has occurred in the network . Taking the first network element being the AF and the second network element being the PCF as an example, after the PCF obtains first packet delays of two consecutive times, the PCF may calculate a difference between the first packet delays of the two consecutive times, and report the difference to the AF in a case where the difference meets a threshold, so that the AF may learn whether jitter has occurred in the network.

In some embodiments, the first message is transmitted directly from the first network element to the second network element. In some embodiments, the first message is transmitted from the first network element to the second network element via other network elements, or the first message is forwarded from the first network element to the second network element via other network elements. Taking the first network element being the AF and the second network element being the PCF as an example, the first message may be transmitted directly from the AF to the PCF, or the first message may be transmitted from the AF to the PCF via an NEF.

It can be seen that, in the embodiments of the present application, the measurement of the packet delay between the terminal device and the associated device of the terminal device and/or the measurement of the packet delay between the UPF and the DN are supplemented, which facilitate the achievement of the end-to-end QoS control between the DN/UPF and the associated device of the terminal device, thereby enhancing the QoS monitoring mechanism.

That is, compared with the current QoS monitoring mechanism that can only be used to measure the packet delay between the terminal device and the UPF and the RTT between the terminal device and the UPF, in the embodiments of the present application, relevant measurement mechanisms for measuring the packet delay between the UPF and the DN and the packet delay between the terminal device and the associated device of the terminal device are supplemented, which can enhance the end-to-end QoS control for the service.

The methods in the embodiments of the present application are mainly applied to a scenario where QoS monitoring is performed on the packet delay, however, the embodiments of the present application are not limited thereto. The methods in the embodiments of the present application may also be applied to other QoS monitoring scenarios, for example, a scenario where QoS monitoring is performed on congestion information.

In some embodiments, the first packet delay may include one or more of: an uplink delay, a downlink delay or a round-trip time.

Taking the first packet delay being the packet delay between the DN and the associated device of the first terminal device as an example, the first packet delay including an uplink delay may mean that the first packet delay includes an uplink packet delay between the DN and the associated device of the first terminal device.

Taking the first packet delay being the packet delay between the DN and the associated device of the first terminal device as an example, the first packet delay including a downlink delay may mean that the first packet delay includes a downlink packet delay between the DN and the associated device of the first terminal device.

Taking the first packet delay being the packet delay between the DN and the associated device of the first terminal device as an example, the first packet delay including a round-trip time may mean that the first packet delay includes a round-trip packet delay between the DN and the associated device of the first terminal device.

Taking the first packet delay being the packet delay between the UPF and the associated device of the first terminal device as an example, the first packet delay including an uplink delay may mean that the first packet delay includes an uplink packet delay between the UPF and the associated device of the first terminal device.

Taking the first packet delay being the packet delay between the UPF and the associated device of the first terminal device as an example, the first packet delay including a downlink delay may mean that the first packet delay includes a downlink packet delay between the UPF and the associated device of the first terminal device.

Taking the first packet delay being the packet delay between the UPF and the associated device of the first terminal device as an example, the first packet delay including a round-trip time may mean that the first packet delay includes a round-trip packet delay between the UPF and the associated device of the first terminal device.

Taking the first packet delay being the packet delay between the first terminal device and the associated device of the first terminal device as an example, the first packet delay including an uplink delay may mean that the first packet delay includes an uplink packet delay between the first terminal device and the associated device of the first terminal device.

Taking the first packet delay being the packet delay between the first terminal device and the associated device of the first terminal device as an example, the first packet delay including a downlink delay may mean that the first packet delay includes a downlink packet delay between the first terminal device and the associated device of the first terminal device.

Taking the first packet delay being the packet delay between the first terminal device and the associated device of the first terminal device as an example, the first packet delay including a round-trip time may mean that the first packet delay includes a round-trip packet delay between the first terminal device and the associated device of the first terminal device.

Taking the first packet delay being the packet delay between the UPF and the DN as an example, the first packet delay including an uplink delay may mean that the first packet delay includes an uplink packet delay between the UPF and the DN.

Taking the first packet delay being the packet delay between the UPF and the DN as an example, the first packet delay including a downlink delay may mean that the first packet delay includes a downlink packet delay between the UPF and the DN.

Taking the first packet delay being the packet delay between the UPF and the DN as an example, the first packet delay including a round-trip time may mean that the first packet delay includes a round-trip packet delay between the UPF and the DN.

Taking the first packet delay being the packet delay between the first associated device of the first terminal device and the second associated device, forwarded via the UPF, as an example, the first packet delay including an uplink delay may mean that the first packet delay includes an uplink packet delay between the first associated device of the first terminal device and the second associated device, forwarded via the UPF.

Taking the first packet delay being the packet delay between the first associated device of the first terminal device and the second associated device, forwarded via the UPF, as an example, the first packet delay including a downlink delay may mean that the first packet delay includes a downlink packet delay between the first associated device of the first terminal device and the second associated device, forwarded via the UPF.

Taking the first packet delay being the packet delay between the first associated device of the first terminal device and the second associated device, forwarded via the UPF, as an example, the first packet delay including a round-trip time may mean that the first packet delay includes a round-trip packet delay between the first associated device of the first terminal device and the second associated device, forwarded via the UPF.

Taking the first packet delay being the packet delay between the first associated device of the first terminal device and the second associated device, forwarded via the UPF, as an example, the first packet delay including an uplink delay may mean that the first packet delay includes an uplink packet delay between the first associated device of the first terminal device and the second associated device, forwarded via the UPF.

Taking the first packet delay being the packet delay between the first associated device of the first terminal device and the second associated device, forwarded via the UPF, as an example, the first packet delay including a downlink delay may mean that the first packet delay includes a downlink packet delay between the first associated device of the first terminal device and the second associated device, forwarded via the UPF.

Taking the first packet delay being the packet delay between the first associated device of the first terminal device and the second associated device, forwarded via the UPF, as an example, the first packet delay including a round-trip time may mean that the first packet delay includes a round-trip packet delay between the first associated device of the first terminal device and the second associated device, forwarded via the UPF.

Taking the first packet delay being the packet delay between the first associated device of the first terminal device and the second associated device, forwarded via the DN, as an example, the first packet delay including an uplink delay may mean that the first packet delay includes an uplink packet delay between the first associated device of the first terminal device and the second associated device, forwarded via the DN.

Taking the first packet delay being the packet delay between the first associated device of the first terminal device and the second associated device, forwarded via the DN, as an example, the first packet delay including a downlink delay may mean that the first packet delay includes a downlink packet delay between the first associated device of the first terminal device and the second associated device, forwarded via the DN.

Taking the first packet delay being the packet delay between the first associated device of the first terminal device and the second associated device, forwarded via the DN, as an example, the first packet delay including a round-trip time may mean that the first packet delay includes a round-trip packet delay between the first associated device of the first terminal device and the second associated device, forwarded via the DN.

Taking the first packet delay being the packet delay between the first terminal device and the associated device of the first terminal device, forwarded via the UPF, as an example, the first packet delay including an uplink delay may mean that the first packet delay includes an uplink packet delay between the first terminal device and the associated device of the first terminal device, forwarded via the UPF.

Taking the first packet delay being the packet delay between the first terminal device and the associated device of the first terminal device, forwarded via the UPF, as an example, the first packet delay including a downlink delay may mean that the first packet delay includes a downlink packet delay between the first terminal device and the associated device of the first terminal device, forwarded via the UPF.

Taking the first packet delay being the packet delay between the first terminal device and the associated device of the first terminal device, forwarded via the UPF, as an example, the first packet delay including a round-trip time may mean that the first packet delay includes a round-trip packet delay between the first terminal device and the associated device of the first terminal device, forwarded via the UPF.

Taking the first packet delay being the packet delay between the first terminal device and the associated device of the first terminal device, forwarded via the DN, as an example, the first packet delay including an uplink delay may mean that the first packet delay includes an uplink packet delay between the first terminal device and the associated device of the first terminal device, forwarded via the DN.

Taking the first packet delay being the packet delay between the first terminal device and the associated device of the first terminal device, forwarded via the DN, as an example, the first packet delay including a downlink delay may mean that the first packet delay includes a downlink packet delay between the first terminal device and the associated device of the first terminal device, forwarded via the DN.

Taking the first packet delay being the packet delay between the first terminal device and the associated device of the first terminal device, forwarded via the DN, as an example, the first packet delay including a round-trip time may mean that the first packet delay includes a round-trip packet delay between the first terminal device and the associated device of the first terminal device, forwarded via the DN.

Taking the first packet delay being the packet delay between the second terminal device and the associated device of the first terminal device, forwarded via the UPF, as an example, the first packet delay including an uplink delay may mean that the first packet delay includes an uplink packet delay between the second terminal device and the associated device of the first terminal device, forwarded via the UPF.

Taking the first packet delay being the packet delay between the second terminal device and the associated device of the first terminal device, forwarded via the UPF, as an example, the first packet delay including a downlink delay may mean that the first packet delay includes a downlink packet delay between the second terminal device and the associated device of the first terminal device, forwarded via the UPF.

Taking the first packet delay being the packet delay between the second terminal device and the associated device of the first terminal device, forwarded via the UPF, as an example, the first packet delay including a round-trip time may mean that the first packet delay includes a round-trip packet delay between the second terminal device and the associated device of the first terminal device, forwarded via the UPF.

Taking the first packet delay being the packet delay between the second terminal device and the associated device of the first terminal device, forwarded via the DN, as an example, the first packet delay including an uplink delay may mean that the first packet delay includes an uplink packet delay between the second terminal device and the associated device of the first terminal device, forwarded via the DN.

Taking the first packet delay being the packet delay between the second terminal device and the associated device of the first terminal device, forwarded via the DN, as an example, the first packet delay including a downlink delay may mean that the first packet delay includes a downlink packet delay between the second terminal device and the associated device of the first terminal device, forwarded via the DN.

Taking the first packet delay being the packet delay between the second terminal device and the associated device of the first terminal device, forwarded via the DN, as an example, the first packet delay including a round-trip time may mean that the first packet delay includes a round-trip packet delay between the second terminal device and the associated device of the first terminal device, forwarded via the DN.

In the embodiments of the present application, the round-trip time (or end-to-end round-trip time, round-trip packet delay or the like) under different scenarios may be different. For example, the round-trip time in the embodiments of the present application may include: a round-trip time of uplink and downlink service data flows that are carried on the same associated device of the terminal device (i.e., the same associated device); a round-trip time of uplink and downlink service data flows that are carried on different associated devices of the terminal device; and a round-trip time of uplink and downlink service data flows that are carried on the terminal device and the associated device of the terminal device, respectively.

As an example, in the application scenario of FIG. 4, the round-trip time may refer to the round-trip time of uplink and downlink service data flows that are carried on the same associated device of the terminal device. As another example, in the application scenario of FIG. 5, the round-trip time may refer to the round-trip time of uplink and downlink service data flows that are carried on different associated devices of terminal device(s), and the uplink and downlink service data flows are carried on different associated devices of the terminal device corresponding to the same terminal device. As another example, in the application scenario of FIG. 6, the round-trip time may refer to the round-trip time of the uplink and downlink service data flows that are carried on the terminal device and the associated device of the terminal device, respectively.

In some embodiments, the difference in the round-trip time is related to various factors. For example, the difference in the round-trip time is related to one or more of the following factors: a topological relationship between a terminal device and an associated device of a terminal device, or a service flow diversion mode.

As mentioned above, the first message may be used to request QoS monitoring for the first packet delay, and the content of the first message is introduced in detail below.

For example, the first message may include one or more of the pieces of following information: a parameter to be measured, relevant indication information of measurement result reporting, relevant information of the terminal device, relevant information of the associated device of the terminal device, relevant information of the first network element, relevant information of the service data flow, or the like.

The parameter to be measured may be used to indicate relevant information of the first packet delay, that is, the first packet delay to be measured is indicated by the parameter. As an example, the parameter to be measured may include the packet delay between the DN and the associated device of the terminal device, for example, include one or more of: an uplink delay between the DN and the associated device of the terminal device, a downlink delay between the DN and the associated device of the terminal device, or a round-trip time when the uplink and downlink service data flows are carried on the same associated device of the terminal device (i.e., the same associated device). As another example, the parameter to be measured may include the packet delay between the UPF and the associated device of the terminal device, for example, include one or more of: an uplink delay between the UPF and the associated device of the terminal device, a downlink delay between the UPF and the associated device of the terminal device, or a round-trip time when the uplink and downlink service data flows are carried on the same associated device of the terminal device (i.e., the same associated device). As yet another example, the parameter to be measured may include the packet delay between the terminal device and the associated device of the terminal device. As still another example, the parameter to be measured may include the packet delay between the UPF and the DN, for example, include one or more of: an uplink delay between the UPF and the DN, a downlink delay between the UPF and the DN, or a round-trip time between the UPF and the DN.

The detailed introduction to the first packet delay or the related introduction to the parameter to be measured may refer to the previous introduction to the first packet delay, which will not be repeated here for the sake of brevity.

The relevant indication information of the measurement result reporting may refer to information related to the measurement reporting of the first packet delay. For example, the relevant indication information of the measurement result reporting may include one or more of: indication information of frequency of the measurement result reporting, indication information of a target network entity of the measurement result reporting (or indication information of a reporting target), or indication information of directly reporting.

The implementation of the frequency of the measurement result reporting is not limited in the embodiments of the present application. In some embodiments, the measurement result reporting may be triggered by an event. In some embodiments, the measurement result may be reported periodically.

In some embodiments, the first message may include indication information of the measurement result reporting manner. For example, the indication information may be used to indicate that the measurement result reporting is triggered based on an event, or that the measurement result is reported periodically.

In some embodiments, in a case where the measurement result reporting is triggered based on an event, the first message may include relevant information of the event. For example, the first message may include a reporting threshold corresponding to the event, that is, when the parameter to be measured (the first packet delay) reaches the reporting threshold, the measurement result reporting is triggered.

In some embodiments, in a case where the measurement result is reported periodically, the first message may include information related to a reporting period. For example, the first message may include a reporting period of the parameter to be measured (the first packet delay), and/or a minimum waiting time between two reports, or the like.

The indication information of the target network entity of the measurement result reporting may be used to indicate a reporting target of the parameter to be measured (the first packet delay), that is, a target object of the measurement result reporting. For example, the indication information of the target network entity of the measurement result reporting may include one or more of: a first network element, a network element in the core network, or the like. For example, the indication information of the target network entity of the measurement result reporting may be used to indicate that the measurement result is reported to one or more of the AF, the PCF, the NEF, the SMF, the terminal device, or the like.

In some embodiments, in a case where the first message includes the indication information of directly reporting, a network element (e.g., the UPF) that determines the monitoring result of the first packet delay may directly report the monitoring result to the first network element or the network element in the core network. For example, when the first message includes the indication information of directly reporting, the UPF may directly report the monitoring result to the AF or NEF, or the like.

The relevant information of the terminal device in the first message may be used to indicate an identity or an address of the terminal device. For example, the first message may include address information (e.g., an IP address or a MAC address) of the terminal device and/or an identifier of the terminal device.

The relevant information of the associated device of the terminal device in the first message may be used to indicate an identity or an address of the associated device of the terminal device. For example, the first message may include address information (e.g., an IP address or a MAC address) of the associated device of the terminal device and/or an identifier of the associated device of the terminal device.

In some embodiments, in a case where the parameter to be measured or the first packet delay includes the packet delay between the terminal device and the associated device of the terminal device, the first message may include the relevant information of the associated device of the terminal device. As an example, in a case where the first packet delay is the packet delay between the DN/UPF and the associated device of the terminal device, the first message may include the relevant information of the associated device of the terminal device. As another example, in a case where the first packet delay is the packet delay between the terminal device and the associated device of the terminal device, the first message may include the relevant information of the associated device of the terminal device. As yet another example, in a case where the first packet delay is the packet delay between the first associated device and the second associated device, forwarded via the UPF/DN, the first message may include relevant information of the first associated device and/or relevant information of the second associated device. As still another example, in a case where the first packet delay is the packet delay between the terminal device and the associated device of the terminal device, forwarded via the UPF/DN, the first message may include the relevant information of the associated device of the terminal device.

In some embodiments, the first message may include the relevant information of the first network element, to indicate a network element that initiates the QoS monitoring request. For example, the relevant information of the first network element included in the first message may be used to indicate an identity of the first network element, for example, the first message may include an identifier of the first network element. Taking the first network element being the AF as an example, the first message may include an identifier of the AF.

In some embodiments, the first message may include the relevant information of the service data flow, for example, may include information such as flow description information and packet filter (composed of information such as a flow direction, IP quintuple).

In some embodiments, the first message may further include relevant information of an external application, for example, may include an identifier of the external application.

In some embodiments, after the first network element transmits the first message to request QoS monitoring for the first packet delay, the first network element may further receive a corresponding monitoring result, which will be described below in conjunction with FIG. 7.

Continuing to refer to FIG. 7, in some embodiments, the method illustrated in FIG. 7 may further include step S720. In step S720, the first network element receives a monitoring result.

In some embodiments, the monitoring result may include one or more of: the first packet delay, or a segment delay in the first packet delay. It is to be understood that the first packet delay mentioned in the embodiments of the present application may refer to an end-to-end packet delay between two communication nodes, and the segment delay in the first packet delay may include a packet delay between two adjacent nodes through which a data transmission path between the two communication nodes passes.

The two adjacent nodes may refer to an end node and its adjacent node on the data transmission path, or may refer to two adjacent intermediate nodes on the data transmission path (in a case where there are multiple intermediate nodes between the two communicating nodes).

As an example, the first packet delay is an end-to-end packet delay between the following two communication nodes: the DN and the associated device of the terminal device; and the segment delay in the first packet delay may include one or more of: a packet delay between the DN and the UPF, a packet delay between the UPF and the access network device, a packet delay between the access network device and the terminal device, or a packet delay between the terminal device and the associated device of the terminal device.

In the above example, the two adjacent nodes may refer to the DN and UPF; or the two adjacent nodes may refer to the UPF and access network device; or the two adjacent nodes may refer to the access network device and terminal device; or the two adjacent nodes may refer to the terminal device and the associated device of the terminal device.

As another example, the first packet delay is the packet delay between the terminal device and the associated device of the terminal device, forwarded via the UPF; and the segment delay in the first packet delay may include one or more of: a packet delay between the UPF and the access network device, a packet delay between the access network device and the terminal device, or a packet delay between the terminal device and the associated device of the terminal device.

In the above example, the two adjacent nodes may refer to the UPF and the access network device; or the two adjacent nodes may refer to the access network device and the terminal device; or the two adjacent nodes may refer to the terminal device and the associated device of the terminal device.

In some embodiments, the monitoring result may only include the first packet delay, that is, the monitoring result includes a total end-to-end delay. For example, the first packet delay refers to the end-to-end packet delay between the following two communication nodes: the DN and the associated device of the terminal device, and the above monitoring result only may include an end-to-end delay between the DN and the associated device of the terminal device.

In some embodiments, the monitoring result may include the segment delay in the first packet delay, for example, include a segment delay of each part in the first packet delay. For example, the first packet delay refers to the end-to-end packet delay between the following two communication nodes: the DN and the associated device of the terminal device, and the above monitoring result may include the packet delay between the DN and UPF, the packet delay between the UPF and the access network device, the packet delay between the access network device and the terminal device, and the packet delay between the terminal device and the associated device of the terminal device. However, the embodiments of the present application are not limited thereto. For example, the monitoring result may include partial of segment delays, taking the first packet delay being the end-to-end packet delay between the two communication nodes (i.e., the DN and the associated device of the terminal device) as an example, the monitoring result may include the packet delay between the DN and UPF, and the packet delay between the terminal device and the associated device of the terminal device.

In some embodiments, the monitoring result may include both the first packet delay and the segment delay in the first packet delay, for example, include the first packet delay and a segment delay of each part in the first packet delay. For example, the first packet delay refers to the end-to-end packet delay between the following two communication nodes: the DN and the associated device of the terminal device, the above monitoring result may include the end-to-end delay between the DN and the associated device of the terminal device, the packet delay between the DN and UPF, the packet delay between the UPF and the access network device, the packet delay between the access network device and the terminal device, and the packet delay between the terminal device and the associated device of the terminal device. However, the embodiments of the present application are not limited thereto. For example, the above monitoring result may include the first packet delay and partial of segment delays, taking the first packet delay being the end-to-end packet delay between the two communication nodes (i.e., the DN and the associated device of the terminal device) as an example, the monitoring result may include the end-to-end delay between the DN and the associated device of the terminal device, the packet delay between the DN and UPF, and the packet delay between the terminal device and the associated device of the terminal device.

In some embodiments, after receiving the first message transmitted by the first network element, the second network element may indicate other network element(s) to perform QoS monitoring on the first packet delay according to the first message, which will be described in detail below in conjunction with FIG. 8.

FIG. 8 is a schematic flowchart of a wireless communication method provided by another embodiment of the present application. The method illustrated in FIG. 8 is introduced from the perspective of interaction among the first network element, the second network element and a third network element.

In some embodiments, the third network element may be used to indicate other network element(s) to measure the first packet delay or the segment delay in the first packet delay.

In some embodiments, the third network element may be used to provide session management function.

In some embodiments, the third network element may be a network element in the core network.

For example, taking the NR system as an example, the third network element may be the SMF. However, the embodiments of the present application are not limited thereto. The third network element may also be other network elements for providing the session management function. For example, the third network element may be a network element, node or device that provides the session management function in the future communication systems.

The method illustrated in FIG. 8 may include step S810 and step S820. These steps are described below.

In step S810, a first network element transmits a first message to a second network element, where the first message is used to request QoS monitoring for a first packet delay.

The detailed description of step S810 refers to the above description of step S710, which will not be repeated here for the sake of brevity.

In step S820, the second network element transmits a second message to a third network element, where the second message may be used to indicate the third network element to perform QoS monitoring on the first packet delay.

In some embodiments, the second message carries a PCC rule; or the second message is transmitted to the third network element in a form of the PCC rule.

In some embodiments, the second message includes a QoS monitoring policy for the first packet delay generated by the second network element, such as an authorized QoS monitoring policy for the first packet delay.

In some embodiments, the QoS monitoring policy for the first packet delay is determined by the second network element based on the received first message and/or local configuration information. For example, the QoS monitoring policy for the first packet delay is determined by the second network element based on the relevant information of the first packet delay in the first message and the local configuration information of the second network element.

In some embodiments, in a case where the first packet delay is a packet delay between different associated devices of the terminal device, forwarded via the UPF, the second message may be used to indicate the third network element to perform monitoring on a packet delay between each of the different associated devices of the terminal device and the UPF, respectively.

For example, in a case where the first packet delay is a packet delay between the first associated device of the first terminal device and the second associated device, forwarded via the UPF, the second message may be used to indicate the third network element to perform monitoring on a second packet delay and a third packet delay, respectively, where the second packet delay and the third packet delay may be used to indicate a packet delay between the first associated device and the UPF and a packet delay between the second associated device and the UPF, respectively. For example, the second packet delay may be the packet delay between the first associated device and the UPF, and the third packet delay may be the packet delay between the second associated device and the UPF.

It is to be understood that the second associated device may be an associated device of the first terminal device or an associated device of the second terminal device. It is to be noted that the definition of the second associated device mentioned below is the same, which will not be explained below for the sake of brevity.

In some embodiments, in a case where the first packet delay is a packet delay between different associated devices of the terminal device, forwarded via the DN, the second message may be used to indicate the third network element to perform monitoring on a packet delay between each of the different associated devices of the terminal device and the DN, respectively.

For example, in a case where the first packet delay is a packet delay between the first associated device of the first terminal device and the second associated device, forwarded via the DN, the second message may be used to indicate the third network element to perform monitoring on a second packet delay and a third packet delay, respectively, where the second packet delay and the third packet delay may be used to indicate a packet delay between the first associated device and the DN and a packet delay between the second associated device and the DN, respectively. For example, the second packet delay may be the packet delay between the first associated device and the DN, and the third packet delay may be the packet delay between the second associated device and the DN.

In some embodiments, in a case where the first packet delay is a packet delay between the terminal device and the associated device of the terminal device, forwarded via the UPF, the second message may be used to indicate the third network element to perform monitoring on a packet delay between the terminal device and the UPF and a packet delay between the associated device of the terminal device and the UPF, respectively. For example, the second message may be used to indicate the third network element to perform monitoring on a second packet delay and a third packet delay, respectively, where the second packet delay may be the packet delay between the terminal device and the UPF, and the third packet delay may be the packet delay between the associated device of the terminal device and the UPF.

In some embodiments, in a case where the first packet delay is a packet delay between the terminal device and the associated device of the terminal device, forwarded via the UPF, the second message may be used to indicate the third network element to perform monitoring on a round-trip packet delay between the terminal device and the UPF and a packet delay between the terminal device and the associated device of the terminal device, respectively. For example, the second message may be used to indicate the third network element to perform monitoring on a second packet delay and a third packet delay, respectively, where the second packet delay may be the round-trip packet delay between the terminal device and the UPF, and the third packet delay may be the packet delay between the terminal device and the associated device of the terminal device.

In some embodiments, in a case where the first packet delay is a packet delay between the terminal device and the associated device of the terminal device, forwarded via the DN, the second message may be used to indicate the third network element to perform monitoring on a packet delay between the terminal device and the DN and a packet delay between the associated device of the terminal device and the DN, respectively. For example, the second message may be used to indicate the third network element to perform monitoring on a second packet delay and a third packet delay, respectively, where the second packet delay may be the packet delay between the terminal device and the DN, and the third packet delay may be the packet delay between the associated device of the terminal device and the DN.

In some embodiments, in a case where the first packet delay is a packet delay between the terminal device and the associated device of the terminal device, forwarded via the DN, the second message may be used to indicate the third network element to perform monitoring on a round-trip packet delay between the terminal device and the DN and a packet delay between the terminal device and the associated device of the terminal device, respectively. For example, the second message may be used to indicate the third network element to perform monitoring on the second packet delay and the third packet delay, respectively, where the second packet delay may be the round-trip packet delay between the terminal device and the DN, and the third packet delay may be the packet delay between the terminal device and the associated device of the terminal device.

In some embodiments, in a case where the first packet delay is a packet delay between the second terminal device and the associated device of the first terminal device, forwarded via the UPF, the second message may be used to indicate the third network element to perform monitoring on a packet delay between the second terminal device and the UPF and a packet delay between the associated device of the first terminal device and the UPF, respectively. For example, the second message may be used to indicate the third network element to perform monitoring on a second packet delay and a third packet delay, respectively, where the second packet delay may be the packet delay between the second terminal device and the UPF, and the third packet delay may be the packet delay between the associated device of the first terminal device and the UPF.

In some embodiments, in a case where the first packet delay is a packet delay between the second terminal device and the associated device of the first terminal device, forwarded via the DN, the second message may be used to indicate the third network element to perform monitoring on a packet delay between the second terminal device and the DN and a packet delay between the associated device of the first terminal device and the DN, respectively. For example, the second message may be used to indicate the third network element to perform monitoring on a second packet delay and a third packet delay, respectively, where the second packet delay may be the packet delay between the second terminal device and the DN, and the third packet delay may be the packet delay between the associated device of the first terminal device and the DN.

In some embodiments, in a case where the first packet delay includes a packet delay between the terminal device and the associated device of the terminal device, the second message may include relevant information of the associated device of the terminal device. For example, the second message may include one or more of: an address of the associated device of the terminal device, or an identifier of the associated device of the terminal device.

In some embodiments, after receiving the second message and completing the relevant QoS monitoring, the third network element may feed back a monitoring result to the second network element, which will be described below in conjunction with FIG. 8.

Referring to FIG. 8, in some embodiments, the method illustrated in FIG. 8 may further include step S830. In step S830, the third network element transmits a monitoring result to the second network element. The monitoring result transmitted by the third network element to the second network element is not limited in the embodiments of the present application, and several examples of the monitoring result transmitted by the third network element to the second network element are given below.

As an implementation, the monitoring result includes a monitoring result of the second packet delay and a monitoring result of the third packet delay mentioned above. In this case, after receiving the monitoring result, the second network element may determine a monitoring result of the first packet delay according to the monitoring result of the second packet delay and the monitoring result of the third packet delay.

In some embodiments, the monitoring result of the first packet delay is calculated based on the monitoring result of the second packet delay and the monitoring result of the third packet delay. For example, the second packet delay and the third packet delay are segment delays in the first packet delay, and the monitoring result of the first packet delay may be determined based on the second packet delay, the third packet delay and other segment delays in the first packet delay. For example, the first packet delay may be a sum of the second packet delay, the third packet delay and other segment delays in the first packet delay.

The second packet delay and the third packet delay are not specifically limited in the embodiments of the present application, which may be any of the second packet delay and third packet delay mentioned above. For example, in a case where the first packet delay is the packet delay between different associated devices of the terminal device, forwarded via the UPF, then the second packet delay and the third packet delay may be the packet delay between the first associated device and UPF and the packet delay between the second associated device and UPF, respectively. Alternatively, in a case where the first packet delay is the packet delay between the second terminal device and the associated device of the first terminal device, forwarded via the DN, the second packet delay and the third packet delay may be the packet delay between the second terminal device and the DN and the packet delay between the associated device of the first terminal device and the DN, respectively. Alternatively, in a case where the first packet delay is the packet delay between the terminal device and the associated device of the terminal device, forwarded via the DN, the second packet delay and the third packet delay may be the packet delay between the terminal device and the DN and the packet delay between the associated device of the terminal device and the DN, respectively; or the second packet delay and the third packet delay may be the round-trip packet delay between the terminal device and the DN and the packet delay between the terminal device and the associated device of the terminal device, respectively.

In some embodiments, after determining the monitoring result of the first packet delay based on the monitoring result of the second packet delay and the monitoring result of the third packet delay, the second network element may transmit the monitoring result of the first packet delay to the first network element. For example, (the monitoring results of) the first packet delay and/or the segment delay of the first packet delay are transmitted.

As another implementation, the monitoring result transmitted by the third network element to the second network element may be the monitoring result of the first packet delay. That is, the third network element may determine the monitoring result of the first packet delay according to the monitoring result of the second packet delay and the monitoring result of the third packet delay, and transmit the monitoring result of the first packet delay to the second network element. In such implementation, the monitoring result transmitted by the third network element to the second network element may include one or more of: the first packet delay, or the segment delay in the first packet delay.

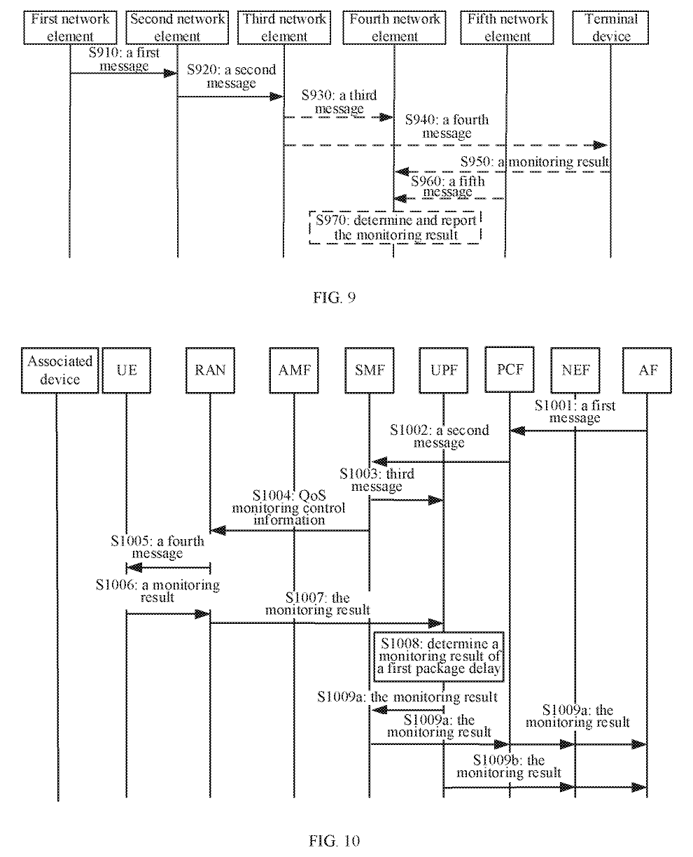

In some embodiments, after receiving the second message, the third network element may request a corresponding network element to perform monitoring on the QoS parameter for the first packet delay according to the second message. In other words, the third network element may determine control information of the QoS parameter to be measured from the second message, and request the corresponding network element to perform the policy of the QoS parameter, which will be described below in conjunction with FIG. 9.

FIG. 9 is a schematic flowchart of a wireless communication method provided by yet another embodiment of the present application. The method illustrated in FIG. 9 is introduced from the perspective of interaction among multiple network elements, nodes or devices. The method illustrated in FIG. 9 may include steps S910 to S940.

In step S910, a first network element transmits a first message to a second network element, where the first message is used to request QoS monitoring for a first packet delay.

The introduction of step S910 refers to the relevant introduction of step S710 above, which will not be repeated here for the sake of brevity.

In step S920, the second network element transmits a second message to a third network element, where the second message is used to indicate the third network element to perform QoS monitoring on the first packet delay.

The introduction of step S920 refers to the relevant introduction of step S820 above, which will not be repeated here for the sake of brevity.

In step S930, in a case where the first packet delay includes a packet delay between a UPF and a DN, the third network element transmits a third message to a fourth network element, where the third message is used to request the fourth network element to perform QoS monitoring on the packet delay between the UPF and the DN.

In some embodiments, the fourth network element may be used to perform QoS monitoring on the packet delay between the UPF and the DN.

In some embodiments, the fourth network element may be a network element in the core network. For example, the fourth network element may be a user plane network element in the core network.

Taking the NR system as an example, the fourth network element may be the UPF. However, the embodiments of the present application are not limited thereto. The fourth network element may further be other network elements that can perform QoS monitoring on the packet delay between the UPF and the DN. For example, the fourth network element may be a network element, node or device in the future communication systems that can perform QoS monitoring on the packet delay between the UPF and the DN.

In some embodiments, the first packet delay including the packet delay between the UPF and the DN may include one or more of: that the first packet delay is a packet delay between the DN and the associated device of the terminal device, that the first packet delay is a packet delay between the UPF and the DN, that the first packet delay is a packet delay between the first associated device and the second associated device, forwarded via the DN, that the first packet delay is a packet delay between a terminal device and an associated device of a terminal device, forwarded via the DN (for example, the first packet delay is a packet delay between the first terminal device and the associated device of the first terminal device, forwarded via the DN, or the first packet delay is a packet delay between the second terminal device and the associated device of the first terminal device, forwarded via the DN) or the like.

In some embodiments, the packet delay between the UPF and the DN may include one or more of: an uplink delay, a downlink delay, or a round-trip time.

In some embodiments, the third message may include QoS monitoring control information determined by the third network element (i.e., QoS monitoring control information for the first packet delay).

In some embodiments, the third network element may configure the fourth network element to perform QoS monitoring on a target QoS flow. That is, the third network element may configure the fourth network element to perform QoS monitoring on a QoS flow for the first packet delay.

In some embodiments, the third network element may further provide the fourth network element with one or more of the following pieces of information: a QoS parameter to be measured, a measurement reporting period, a measurement reporting frequency, a target network entity of measurement reporting, or the like. In some embodiments, one or more of the above pieces of information may be carried by the third network element in a session reporting rule (SRR).

In some embodiments, the fourth network element may be determined by the third network element based on one or more of the following pieces of information: an address of a terminal device, flow description information, a data network name (DNN), single network slice selection assistance information (S-NSSAI), an application identifier, or the like.

In some embodiments, the target QoS flow (the QoS flow for the first packet delay) monitored by the fourth network element may be determined by a QFI.

In some embodiments, in a case where the first packet delay includes a packet delay between the UPF and the access network device, the fourth network element further needs to measure the packet delay between the UPF (e.g., an anchor UPF) and the access network device. For example, in a case where the first packet delay includes the packet delay between the UPF and the access network device, the fourth network element needs to cooperate with the access network device to measure the packet delay between the UPF and the access network device.

In some embodiments, the first packet delay including the packet delay between the UPF and the access network device may include one or more of: that the first packet delay is a packet delay between the DN and the associated device of the terminal device, that the first packet delay is a packet delay between the UPF and the associated device of the terminal device, that the first packet delay is a packet delay between the first associated device and the second associated device, forwarded via the UPF, that the first packet delay is a packet delay between the first associated device and the second associated device, forwarded via the DN, that the first packet delay is a packet delay between a terminal device and an associated device of a terminal device, forwarded via the UPF (for example, the first packet delay is a packet delay between the first terminal device and the associated device of the first terminal device, forwarded via the UPF, or the first packet delay is a packet delay between the second terminal device and the associated device of the first terminal device, forwarded via the UPF), that the first packet delay is a packet delay between a terminal device and an associated device of a terminal device, forwarded via the DN (for example, the first packet delay is a packet delay between the first terminal device and the associated device of the first terminal device, forwarded via the DN, or the first packet delay is a packet delay between the second terminal device and the associated device of the first terminal device, forwarded via the DN), or the like.

In step S940, in a case where the first packet delay includes the packet delay between the terminal device and the associated device of the terminal device, the third network element transmits a fourth message to the terminal device, where the fourth message is used to request the terminal device to perform QoS monitoring on a packet delay between the terminal device and the associated device of the terminal device.

In some embodiments, the first packet delay including the packet delay between the terminal device and the associated device of the terminal device may include one or more of: that the first packet delay is a packet delay between the DN and the associated device of the terminal device, that the first packet delay is a packet delay between the UPF and the associated device of the terminal device, that the first packet delay is a packet delay between the terminal device and the associated device of the terminal device, that the first packet delay is a packet delay between the first associated device and the second associated device, forwarded via the DN, that the first packet delay is a packet delay between the first associated device and the second associated device, forwarded via the UPF, that the first packet delay is a packet delay between a terminal device and an associated device of a terminal device, forwarded via the DN (for example, the first packet delay is a packet delay between the first terminal device and the associated device of the first terminal device, forwarded via the DN, or the first packet delay is a packet delay between the second terminal device and the associated device of the first terminal device, forwarded via the DN), that the first packet delay is a packet delay between a terminal device and an associated device of a terminal device, forwarded via the UPF (for example, the first packet delay is a packet delay between the first terminal device and the associated device of the first terminal device, forwarded via the UPF, or the first packet delay is a packet delay between the second terminal device and the associated device of the first terminal device, forwarded via the UPF), or the like.

In some embodiments, the fourth message is used to request the terminal device to perform QoS monitoring on one or more of: an uplink packet delay and/or a downlink packet delay between the terminal device and the associated device of the terminal device; a round-trip time between the terminal device and the associated device of the terminal device; packet delays between the terminal device and multiple associated devices of the terminal device; or a one-way packet delay between the terminal device and the associated device of the terminal device.

As an example, in a case where the terminal device has only one associated device, and a source address of an uplink data flow and a destination address of a downlink data flow both point to the associated device (see the scenario illustrated in FIG. 4 above), the terminal device may only measure the uplink and/or downlink packet delays between the terminal device and the associated device; or in other words, the terminal device may measure the uplink packet delay between the terminal device and the associated device.

As another example, in a case where the terminal device has multiple associated devices (e.g., two associated devices), that is, a source address of an uplink data flow is different from a destination address of a downlink data flow, and the uplink and downlink data flows are diverted to different associated devices through the terminal device, then the terminal device may measure the packet delays between the terminal device and multiple associated devices, respectively.

As yet another example, in a case where the terminal device has only one associated device, but a source address of an uplink data flow (e.g., pointing to the terminal device) is different from a destination address of a downlink data flow (e.g., pointing to the associated device), the terminal device may only measure the one-way packet delay between the terminal device and the associated device of the terminal device.

As still another example, in a case where the terminal device has only one associated device, and a source address of an uplink data flow (e.g., pointing to the associated device of the terminal device) is different from a destination address of a downlink data flow (e.g., pointing to the terminal device), the terminal device may only measure the one-way packet delay between the terminal device and the associated device of the terminal device.

In some embodiments, the fourth message may include QoS monitoring control information determined by the third network element (i.e., QoS monitoring control information for the first packet delay).

In some embodiments, a terminal device receiving the fourth message is determined by the third network element according to the address information of the terminal device. For example, the third network element may determine which terminal device(s) to transmit the fourth message to, according to the address information of the terminal device carried in the second message.

In some embodiments, the fourth message (e.g., the QoS monitoring control information included in the fourth message) may include one or more of the following pieces of information: address information of a terminal device, identifier information of a terminal device, address information of an associated device of a terminal device, identifier information of an associated device of a terminal device, flow description information, or packet filter information.

In some embodiments, the fourth message is transmitted from the third network element to the terminal device through intermediate node. Taking the third network element being the SMF as an example, the third network element may transmit the fourth message to the terminal device through the AMF and the access network device.

In some embodiments, the third network element may further transmit the QoS monitoring control information (the QoS monitoring control information for the first packet delay) to the access network device, to configure the access network device to perform QoS monitoring on a target QoS flow. That is, the third network element can configure the access network device to perform QoS monitoring on the QoS flow for the first packet delay.

In some embodiments, in a case where the first packet delay includes a packet delay between the access network device and the terminal device, the third network element may request the access network device to perform monitoring on the packet delay between the access network device and the terminal device. For example, in a case where the first packet delay is a packet delay between the DN/UPF and the associated device of the terminal device or the first packet delay is a packet delay between a terminal device and an associated device of a terminal device, forwarded via the DN/UPF, the third network element may request the access network device to perform monitoring on the packet delay between the access network device and the terminal device.

In some embodiments, in a case where the first packet delay includes a packet delay between the access network device and the UPF, the third network element may configure the access network device to cooperate with the UPF to measure the packet delay between the access network device and the UPF. For example, in a case where the first packet delay is the packet delay between the DN/UPF and the associated device of the terminal device, or the first packet delay is the packet delay between a terminal device and an associated device of a terminal device, forwarded via the DN/UPF, the third network element may configure the access network device to cooperate with the UPF to measure the packet delay between the access network device and the UPF.

In some embodiments, after completing the QoS monitoring, the network element, node or device that performs the QoS monitoring is also necessary to determine and/or report the monitoring result, which will be further described below with reference to FIG. 9.

In some embodiments, the method illustrated in FIG. 9 may include step S950. In step S950, the terminal device transmits the monitoring result to the fourth network element.

In some embodiments, the monitoring result includes one or more of: an uplink packet delay and/or a downlink packet delay between the terminal device and the associated device of the terminal device; a round-trip packet delay between the terminal device and the associated device of the terminal device; packet delays between the terminal device and multiple associated devices of the terminal device; or a one-way packet delay between the terminal device and the associated device of the terminal device.

In some embodiments, the monitoring result is transmitted from the terminal device to the fourth network element via the intermediate node(s). Taking the fourth network element being the UPF as an example, the monitoring result may be transmitted from the terminal device to the UPF via the access network device.

In some embodiments, the monitoring result is transmitted from the terminal device to the fourth network element via a user plane. For example, the monitoring result is transmitted from the terminal device to the UPF via the access network device through the user plane.

In some embodiments, the monitoring result is transmitted from the terminal device to the fourth network element via a control plane. For example, the monitoring result is transmitted from the terminal device to the UPF via the access network device through the control plane.

In some embodiments, step S950 may not be performed. For example, in a case where the first network element is the terminal device, that is, the QoS monitoring request for the first packet delay is triggered by the terminal device. In this case, the terminal device is not required to report the packet delay between the terminal device and the associated device of the terminal device, but may request the network to provide the packet delay between the DN/UPF and the terminal device, and then determine the end-to-end delay between the DN/UPF and the associated device of the terminal device.

In some embodiments, the method illustrated in FIG. 9 may include step S960. In step S960, a fifth network element transmits a fifth message to the fourth network element. In some embodiments, the fifth network element may be an access network device, e.g., a base station.

The fifth message includes one or more of: the packet delay between the access network device and the terminal device, or the packet delay between the terminal device and the associated device of the terminal device.

That is, after the terminal device transmits the monitoring result to the access network device (the monitoring result is used to indicate the packet delay between the terminal device and the associated device of the terminal device), the access network device may transmit the monitoring result transmitted by the terminal device and the monitoring result of the packet delay between the access network device and the terminal device measured by the access network device to the fourth network element.

In some embodiments, the method illustrated in FIG. 9 may include step S970. In step S970, the fourth network element determines and reports the monitoring result according to the packet delay in the fifth message and the packet delay monitored by the fourth network element. This monitoring result may be understood as the monitoring result for the first packet delay.

In some embodiments, the monitoring result includes one or more of: a first packet delay for which monitoring is requested, or the segment delay in the first packet delay.

In some embodiments, the packet delay monitored by the fourth network element may include one or more of: the packet delay between the DN and the UPF, or the packet delay between the UPF and the access network device.

In some embodiments, in a case where the first packet delay includes the packet delay between the DN and the UPF, the packet delay monitored by the fourth network element includes the packet delay between the DN and the UPF. As an example, in a case where the first packet delay is a packet delay between the DN and the associated device of the terminal device, the packet delay monitored by the fourth network element includes the packet delay between the DN and the UPF. As another example, in a case where the first packet delay is a packet delay between the DN and the UPF, the packet delay monitored by the fourth network element includes the packet delay between the DN and the UPF.

For ease of understanding, an implementation in which the fourth network element monitors the packet delay between the DN and the UPF is given below.

As an implementation, the fourth network element may read a timestamp of an application layer packet header of a downlink data packet, to obtain transmitting time of the data packet at the DN side (e.g., T0), and record local time of receiving the data packet (e.g., T1). Afterwards, the fourth network element may add a timestamp to an application layer packet header of an uplink data packet to record transmitting time of the uplink data packet (e.g., T2), and record local receiving time (e.g., T3) when the DN side receives the uplink data packet. In this way, the fourth network element may determine that a round-trip time between the UPF and the DN is (T3-T2) + (T1-T0).

In some embodiments, in a case where the DN and the UPF have synchronized local clocks, the fourth network element may further determine that the one-way delay between the UPF and the DN is T3-T2 or T1-T0. In some embodiments, in a case where the DN and the UPF do not have synchronized local clocks, the fourth network element may estimate the one-way delay between the DN and the UPF according to [(T3-T2)+(T1-T0)]/2.

In some embodiments, in a case where the first packet delay includes a packet delay between the UPF and the access network device, the packet delay monitored by the fourth network element includes the packet delay between the UPF and the access network device. As an example, in a case where the first packet delay is a packet delay between the DN and the associated device of the terminal device, the packet delay monitored by the fourth network element includes the packet delay between the UPF and the access network device. As another example, in a case where the first packet delay is a packet delay between the UPF and the associated device of the terminal device, the packet delay monitored by the fourth network element includes the packet delay between the UPF and the access network device.

Thus, the fourth network element may determine the monitoring result according to the packet delay in the fifth message and the packet delay monitored by the fourth network element.

In some embodiments, after determining the monitoring result, the fourth network element may report the monitoring result.

As an implementation, the fourth network element may transmit the monitoring result to the third network element, so that the third network element transmits the monitoring result to the first network element.

In some embodiments, after the fourth network element transmits the monitoring result to the third network element, the third network element may transmit the monitoring result to the second network element. Afterwards, the second network element may transmit the monitoring result to the network element that requests QoS monitoring (i.e., the first network element).

As another implementation, the fourth network element may directly transmit the monitoring result to the network element that requests QoS monitoring (i.e., the first network element). For example, in a case where the first message includes indication information of directly reporting, the fourth network element may directly transmit the monitoring result to the first network element.

In some embodiments, the fourth network element reporting the monitoring result is triggered based on a condition. For example, the fourth network element may report the monitoring result when a threshold corresponding to an event is reached. Alternatively, the fourth network element may periodically report (when a reporting period is reached) the monitoring result.

As an example, the fourth network element may transmit the monitoring result to the third network element when the threshold corresponding to the event is reached. Alternatively, the fourth network element may directly transmit the monitoring result to the first network element when the threshold corresponding to the event is reached.

As another example, the fourth network element may periodically report the monitoring result to the third network element. Alternatively, the fourth network element may periodically report the monitoring result to the first network element directly.

It should be noted that, in the method illustrated in FIG. 9, the node that ultimately counts and reports the monitoring result is the fourth network element, or the node that integrates the segment delays in the first packet delay is the fourth network element. However, the embodiments of the present application are not limited thereto. In some embodiments, the second network element, the third network element, the fifth network element, the terminal device or the like may also serve as nodes for counting and reporting the monitoring result or as nodes for integrating the segment delays in the first packet delay.

It is to be understood that the processes or steps of the wireless communication methods described above may be used in combination with each other. For example, the methods illustrated in FIG. 7, FIG. 8 and/or FIG. 9 may be used in combination. As an example, the methods illustrated FIG. 7 and FIG. 8 may be used in combination. As another example, the methods illustrated FIG. 8 and FIG. 9 may be used in combination. As yet another example, the methods illustrated FIG. 7, FIG. 8 and FIG. 9 may be used in combination, and so on.

For ease of understanding, taking the first network element being an AF and other network elements being network elements in the 5G system as an example, several embodiments are provided below to illustrate the process of packet delay monitoring in the embodiments of the present application. It is to be noted that the detailed description of the concepts mentioned in the steps of the following embodiments may be referred to the above text, such as the information included in the first message.

Embodiment I: AF requests end-to-end packet delay monitoring

In embodiment I, a monitoring result for a packet delay is integrated, calculated and reported by a UPF.

Embodiment I is mainly applied to a scenario where some devices (associated devices of the terminal device) that access a mobile communication network through a 3GPP terminal device serving as a gateway or relay serve as the ultimate entity that interacts directly with the users. Under the scenario, an end-to-end packet delay monitoring requested by an AF may include a delay between a terminal device and an associated device of the terminal device, and/or a delay between a DN and a UPF. The process of packet delay monitoring under the scenario is described with reference to FIG. 10.

FIG. 10 is a schematic flowchart of a wireless communication method provided by yet another embodiment of the present application. The method illustrated in FIG. 10 may include steps S1001 to S1009.

In step S1001, the AF transmits a first message to a PCF, where the first message is used to request QoS monitoring for a first packet delay.

In some embodiments, the AF may directly transmit the first message to the PCF. In some embodiments, the AF may transmit the first message to the PCF via an NEF.

In step S1002, the PCF transmits a second message to an SMF based on the first message.

In some embodiments, the PCF may generate an authorized QoS monitoring policy based on the received first message and local configuration information, and include the authorized QoS monitoring policy in the second message and transmit it to the SMF.

In some embodiments, the second message carries a PCC rule; or the second message is transmitted to the SMF in a form of the PCC rule.

In some embodiments, the SMF may determine control information of a QoS parameter of the first packet delay from the generated authorized QoS monitoring policy, and request a corresponding UPF, access network device and terminal device to perform QoS parameter monitoring.

In step S1003, the SMF transmits a third message to the UPF.

In some embodiments, the SMF may configure the UPF to perform QoS monitoring on a QoS flow for the first packet delay.

In some embodiments, in a case where the first packet delay includes a packet delay between a DN and the associated device of the terminal device, or includes a packet delay between the DN and the UPF, the SMF may configure the UPF to perform monitoring on the packet delay between the UPF and the DN.

In some embodiments, in a case where the first packet delay includes the packet delay between the DN and the associated device of the terminal device, or includes a packet delay between the UPF and the associated device of the terminal device, the SMF may further configure the UPF to cooperate with the access network device to measure a packet delay between the access network device and the UPF.

In step S1004, the SMF transmits a QoS monitoring control message to the access network device, to configure the access network device to perform QoS monitoring on the QoS flow for the first packet delay.

In some embodiments, in a case where the first packet delay includes the packet delay between the DN and the associated device of the terminal device, or includes the packet delay between the UPF and the associated device of the terminal device, the SMF may configure the access network device to cooperate with the UPF to measure the packet delay between the access network device and the UPF.

In step S1005, in a case where the first packet delay includes a delay between the terminal device and the associated device of the terminal device, the SMF transmits a fourth message to the terminal device.

The fourth message may be used to request the terminal device to perform QoS monitoring on the packet delay between the terminal device and the associated device of the terminal device. For example, in a case where the first packet delay is the packet delay between the DN and the associated device of the terminal device, or the packet delay between the UPF and the associated device of the terminal device, or the packet delay between the terminal device and the associated device of the terminal device, the SMF may transmit the fourth message to the terminal device.

In some embodiments, the fourth message is transmitted from the SMF to the terminal device through the AMF and the access network device.

In some embodiments, the terminal device receiving the fourth message is determined based on address information of the terminal device in the second message.

In some embodiments, the fourth message may include one or more of the following pieces of information: address information of the terminal device, identifier information of the terminal device, address information of the associated device of the terminal device, identifier information of the associated device of the terminal device, flow description information, packet filter information or the like.

In some embodiments, the fourth message is used to request the terminal device to perform QoS monitoring on one or more of: an uplink packet delay and/or a downlink packet delay between the terminal device and the associated device of the terminal device; packet delays between the terminal device and multiple associated devices of the terminal device; or a one-way packet delay between the terminal device and the associated device of the terminal device.

In step S1006, the terminal device reports a monitoring result to the UPF. In other words, the terminal device reports the measured packet delay between the terminal device and the associated device of the terminal device to the UPF.

In some embodiments, the monitoring result reported by the terminal device may include one or more of: the uplink packet delay and/or the downlink packet delay between the terminal device and the associated device of the terminal device; the packet delays between the terminal device and the multiple associated devices of the terminal device; or the one-way packet delay between the terminal device and the associated device of the terminal device.

In some embodiments, the terminal device may report the monitoring result to the UPF via the access network device through a user plane. In some embodiments, the terminal device may report the monitoring result to the UPF via the access network device through a control plane.

In step S1007, the access network device reports the monitoring result to the UPF. The monitoring result includes the packet delay between the access network device and the terminal device measured by the access network device, and the packet delay between the terminal device and the associated device of the terminal device measured by the terminal device.

In step S1008, the UPF determines the monitoring result of the first packet delay. The monitoring result includes one or more of: the first packet delay, or a segment delay in the first packet delay. Taking the first packet delay being the packet delay between the DN and the associated device of the terminal device as an example, the monitoring result may include the packet delay between the DN and the associated device of the terminal device, or the monitoring result may further include one or more of the following segment delays: the packet delay between the DN and the UPF, the packet delay between the UPF and the access network device, the packet delay between the access network device and the terminal device, or the packet delay between the terminal device and the associated device of the terminal device.

In some embodiments, in a case where the first packet delay is the packet delay between the UPF and the DN or the packet delay between the DN and the associated device of the terminal device, the UPF is required to measure the packet delay between the UPF and the DN.

In some embodiments, in a case where the first packet delay is the packet delay between the DN and the associated device of the terminal device or the packet delay between the UPF and the associated device of the terminal device, the UPF is also required to measure the packet delay between the access network device and the UPF.

Afterwards, the UPF determines the monitoring result of the first packet delay based on the packet delay between the access network device and the terminal device and/or the packet delay between the terminal device and the associated device of the terminal device in the received monitoring result.

In step S1009, the UPF reports the monitoring result to the AF.

As an implementation, referring to step S1009a, the UPF may report the monitoring result to the SMF, then the SMF reports the monitoring result to the PCF, and finally the PCF reports the monitoring result to the AF (for example, directly reporting to the AF or reporting to the AF through the NEF).

As another implementation, referring to step S1009b, the UPF may directly report the monitoring result to the AF. For example, in a case where the first message carries indication information of directly reporting, the UPF may directly report the monitoring result to the AF.

In some embodiments, in addition to reporting the monitoring result to the AF, the UPF may further report the monitoring result to other target network elements, nodes or devices.

The end-to-end QoS monitoring method proposed in Embodiment I may accurately measure the end-to-end delay between the application server and the associated device of the peer terminal device. Embodiment I further supplements the measurement of the packet delay between the DN and the UPF, and/or supplements the measurement of the packet delay between the terminal device and the associated device of the terminal device under different application scenarios. which assists the application server to adjust the bit rate of the service flow, the bit rate or the resolution of transmitted files or the like according to the QoS monitoring result, so that the service flow may dynamically adapt to the network conditions and ensure the user experience.

Embodiment II: packet delay monitoring between different associated devices of a terminal device forwarded via a mobile communication network

In Embodiment II, a monitoring result for a packet delay is integrated, calculated and reported by a PCF.

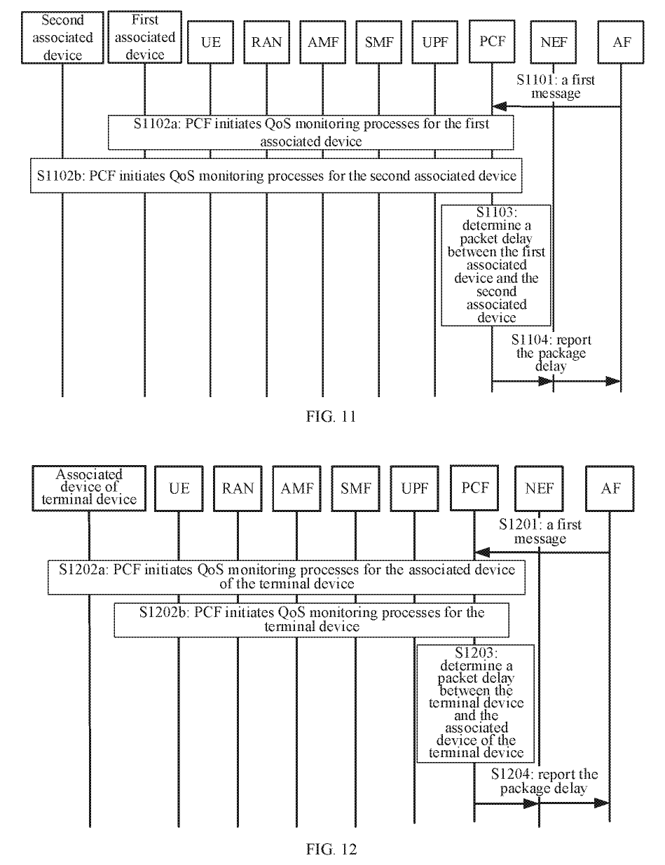

The Embodiment II is mainly applied to QoS monitoring for a packet delay between different associated devices of the terminal device (different associated devices) forwarded via a DN/UPF. The process of packet delay monitoring under the scenario is described below with reference to FIG. 11.

FIG. 11 is a schematic flowchart of a wireless communication method provided by yet another embodiment of the present application. The method illustrated in FIG. 11 may include steps S1101 to S1104.

In step S1101, an AF transmits a first message to the PCF. In some embodiments, the first message may be used to request QoS monitoring for a first packet delay.

In some embodiments, the first packet delay may include: a packet delay between a first associated device and a second associated device, forwarded via the UPF, or a packet delay between the first associated device and the second associated device, forwarded via the DN.

In some embodiments, in addition to including a parameter to be measured (i.e., relevant information of the first packet delay), the first message may further include one or more of: an identifier of the first associated device and an identifier of the second associated device, an address of the first associated device and an address of the second associated device, an identifier of a terminal device associated with or attached to the first associated device, an identifier of a terminal device associated with or attached to the second associated device, an address of the terminal device associated with or attached to the first associated device, or an address of the terminal device associated with or attached to the second associated device.

The introduction of other parameters carried in the first message refers to the introduction above, which will not be repeated here for the sake of brevity.

In step S1102, the PCF initiates QoS monitoring processes for the first associated device and the second associated device, respectively. In other words, the step S1102 may include step S1102a and step S1102b. In step S1102a, the PCF initiates the QoS monitoring process for the first associated device. In step S1102b, the PCF initiates the QoS monitoring process for the second associated device.

In some embodiments, in a case where the first packet delay is a packet delay between the first associated device and the second associated device, forwarded via the UPF, the PCF initiates monitoring for a packet delay between the first associated device and the UPF and monitoring for a packet delay between the second associated device and the UPF, respectively.

In some embodiments, in a case where the first packet delay is a packet delay between the first associated device and the second associated device, forwarded via the DN, the PCF initiates monitoring for a packet delay between the first associated device and the DN and monitoring for a packet delay between the second associated device and the DN, respectively.

In step S1103, the PCF determines the packet delay (end-to-end delay) between the first associated device and the second associated device, or the PCF determines the packet delay between the first associated device and the second associated device, forwarded via the mobile communication network. For example, the PCF determines the packet delay between the first associated device and the second associated device, forwarded via the UPF, or determines the packet delay between the first associated device and the second associated device, forwarded via the DN.

In step S1104, the PCF reports the packet delay between the first associated device and the second associated device, or the PCF reports the obtained packet delay between the first associated device and the second associated device forwarded via the mobile communication network to the AF. For example, the PCF reports an obtained packet delay between the first associated device and the second associated device forwarded via the UPF to the AF, or the PCF reports an obtained packet delay between the first associated device and the second associated device forwarded via the DN to the AF.

In some embodiments, the PCF may report the obtained packet delay between the first associated device and the second associated device, forwarded via the mobile communication network, to other target network elements, such as other target network elements specified in the first message.

Embodiment III: packet delay monitoring between a terminal device and an associated device of a terminal device forwarded via a mobile communication network

In Embodiment III, a monitoring result for a packet delay is integrated, calculated and reported by a PCF.

The Embodiment III is mainly applied to QoS monitoring for a packet delay between a terminal device and an associated device of a terminal device forwarded via a DN/UPF. The process of packet delay monitoring under the scenario is described below with reference to FIG. 12.

FIG. 12 is a schematic flowchart of a wireless communication method provided by yet another embodiment of the present application. The method illustrated in FIG. 12 may include steps S1201 to S1204.

In step S1201, an AF transmits a first message to the PCF. In some embodiments, the first message may be used to request QoS monitoring for a first packet delay.

In some embodiments, the first packet delay may include: a packet delay between the terminal device and the associated device of the terminal device, forwarded via the UPF, or a packet delay between the terminal device and the associated device of the terminal device, forwarded via the DN.

In some embodiments, in addition to including a parameter to be measured (i.e., relevant information of the first packet delay), the first message may further include one or more of: an identifier of a first associated device, an address of the first associated device, an identifier of a terminal device associated with or attached to the first associated device, or an address of the terminal device associated with or attached to the first associated device.

The introduction of other parameters carried in the first message refers to the introduction above, which will not be repeated here for the sake of brevity.

In step S1202, the PCF initiates QoS monitoring processes for the terminal device and the associated device of the terminal device, respectively. In other words, the step S1202 may include step S1202a and step S1202b. In step S1202a, the PCF initiates the QoS monitoring process for the associated devices of the terminal device. In step S1202b, the PCF initiates the QoS monitoring process for the terminal device.

In some embodiments, in a case where the first packet delay is a packet delay between the terminal device and the associated device of the terminal device, forwarded via the UPF, the PCF initiates monitoring for a packet delay between the associated device of the terminal device and the UPF and monitoring for a packet delay between the terminal device and the UPF, respectively.

In some embodiments, in a case where the first packet delay is a packet delay between the terminal device and the associated device of the terminal device, forwarded via the UPF, the PCF initiates monitoring for a round-trip packet delay between the terminal device and the UPF and monitoring for a packet delay between the terminal device and the associated device of the terminal device, respectively.

In some embodiments, in a case where the first packet delay is a packet delay between the terminal device and the associated device of the terminal device, forwarded via the DN, the PCF initiates monitoring for a packet delay between the associated device of the terminal device and the DN and monitoring for a packet delay between the terminal device and the DN, respectively.

In some embodiments, in a case where the first packet delay is a packet delay between the terminal device and the associated device of the terminal device, forwarded via the DN, the PCF initiates monitoring for a round-trip packet delay between the terminal device and the DN and monitoring for a packet delay between the terminal device and the associated device of the terminal device, respectively.

In step S1203, the PCF determines the packet delay (end-to-end delay) between the terminal device and the associated device of the terminal device, or the PCF determines the packet delay between the terminal device and the associated device of the terminal device, forwarded via the mobile communication network. For example, the PCF determines the packet delay between the terminal device and the associated device of the terminal device, forwarded via the UPF, or determines the packet delay between the terminal device and the associated device of the terminal device, forwarded via the DN.

In step S1204, the PCF reports the packet delay between the terminal device and the associated device of the terminal device, or the PCF reports the obtained packet delay between the terminal device and the associated device of the terminal device forwarded via the mobile communication network to the AF. For example, the PCF reports the obtained packet delay between the terminal device and the associated device of the terminal device forwarded via the UPF to the AF, or the PCF reports the obtained packet delay between the terminal device and the associated device of the terminal device forwarded via the DN to the AF.

In some embodiments, the PCF may report the obtained packet delay between the terminal device and the associated device of the terminal device forwarded via the mobile communication network to other target network elements, such as other target network elements specified in the first message.

Based on the method of Embodiment I, the methods in Embodiment II and Embodiment III can measure the end-to-end packet delay monitoring between the different associated devices of the terminal device forwarded via the mobile communication network, and the packet delay monitoring when the uplink and downlink are asymmetric (that is, the end-to-end packet delay monitoring between the terminal device and the associated device of the terminal device, forwarded via the mobile communication network). In this way, the application scenarios of the QoS monitoring mechanism are enriched, allowing the application server or user to perceive the service flow transmission status within the communication system, thereby making timely adaptive adjustments.

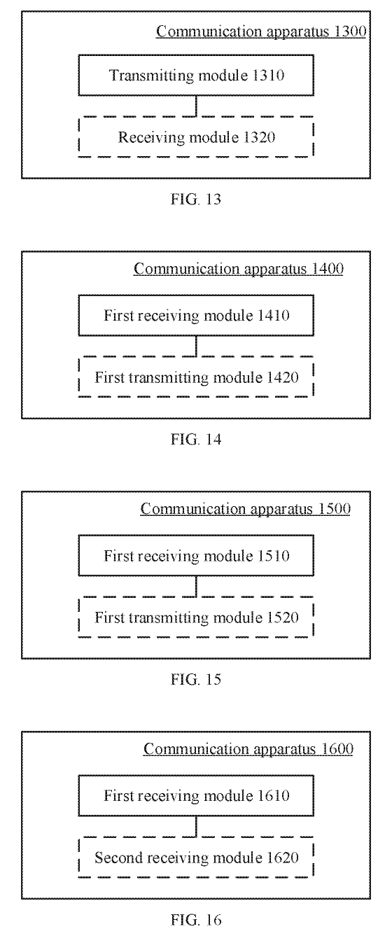

The method embodiments of the present application are described in detail above in conjunction with FIG. 1 to FIG. 12, and the apparatus embodiments of the present application will be described in detail in conjunction with FIG. 13 to FIG. 18. It is to be understood that the description of the method embodiments corresponds to the description of the apparatus embodiments, and therefore, for parts that are not described in detail, reference may be made to the previous method embodiments.

FIG. 13 is a schematic structural diagram of a communication apparatus provided by an embodiment of the present application. The communication apparatus 1300 illustrated in FIG. 13 may be any first network element mentioned above. The communication apparatus 1300 may include a transmitting module 1310.

The transmitting module 1310 may be configured to transmit a first message to a second network element, the first message being used to request QoS monitoring for a first packet delay; where the first packet delay includes one or more of following packet delays: a packet delay between a first terminal device and an associated device of a first terminal device; or a packet delay between a UPF and a DN.

Optionally, the first packet delay is one of following packet delays: a packet delay between the DN and the associated device of the first terminal device; a packet delay between the UPF and the associated device of the first terminal device; the packet delay between the first terminal device and the associated device of the first terminal device; the packet delay between the UPF and the DN; a packet delay between a first associated device of the first terminal device and a second associated device, forwarded via the UPF; a packet delay between the first associated device of the first terminal device and the second associated device, forwarded via the DN; a packet delay between the first terminal device and the associated device of the first terminal device, forwarded via the UPF; a packet delay between the first terminal device and the associated device of the first terminal device, forwarded via the DN; a packet delay between a second terminal device and the associated device of the first terminal device, forwarded via the UPF; or a packet delay between the second terminal device and the associated device of the first terminal device, forwarded via the DN; where the second associated device is the associated device of the first terminal device, or the second associated device is an associated device of the second terminal device.

Optionally, the first packet delay includes one or more of: an uplink delay; a downlink delay; or a round-trip time.

Optionally, in a case where the first packet delay includes the packet delay between the first terminal device and the associated device of the first terminal device, the first message includes one or more of: an address of the associated device of the first terminal device; or an identifier of the associated device of the first terminal device.

Optionally, the communication apparatus 1300 further includes: a receiving module 1320, configured to receive a monitoring result, where the monitoring result includes one or more of: the first packet delay; or a segment delay in the first packet delay.

Optionally, the first packet delay is an end-to-end packet delay between two communication nodes, and the segment delay includes a packet delay between two adjacent nodes through which a data transmission path between the two communication nodes passes.

Optionally, the first network element is an AF, a network element in a core network or a terminal device.

Optionally, the second network element is a PCF.

Optionally, the associated device of the first terminal device is a device that communicates with a mobile communication network through the first terminal device.

Optionally, the associated device of the first terminal device is a 3GPP terminal device; or the associated device of the first terminal device is a non-3GPP device.

Optionally, the transmitting module 1310 may be a transceiver 1830. The communication apparatus 1300 may further include a processor 1810 and a memory 1820, as illustrated in FIG. 18.

FIG. 14 is a schematic structural diagram of a communication apparatus provided by another embodiment of the present application. The communication apparatus 1400 illustrated in FIG. 14 may be any second network element described above. The communication apparatus 1400 may include a first receiving module 1410.

The first receiving module 1410 may be configured to receive a first message transmitted by a first network element, the first message being used to request QoS monitoring for a first packet delay; where the first packet delay includes one or more of following packet delays: a packet delay between a first terminal device and an associated device of the first terminal device; or a packet delay between a UPF and a DN.

Optionally, the first packet delay is one of following packet delays: a packet delay between the DN and the associated device of the first terminal device; a packet delay between the UPF and the associated device of the first terminal device; the packet delay between the first terminal device and the associated device of the first terminal device; the packet delay between the UPF and the DN; a packet delay between a first associated device of the first terminal device and a second associated device, forwarded via the UPF; a packet delay between the first associated device of the first terminal device and the second associated device, forwarded via the DN; a packet delay between the first terminal device and the associated device of the first terminal device, forwarded via the UPF; a packet delay between the first terminal device and the associated device of the first terminal device, forwarded via the DN; a packet delay between a second terminal device and the associated device of the first terminal device, forwarded via the UPF; or a packet delay between the second terminal device and the associated device of the first terminal device, forwarded via the DN; where the second associated device is the associated device of the first terminal device; or the second associated device is an associated device of the second terminal device.

Optionally, the first packet delay includes one or more of: an uplink delay; a downlink delay; or a round-trip time.

Optionally, in a case where the first packet delay includes the packet delay between the first terminal device and the associated device of the first terminal device, the first message includes one or more of: an address of the associated device of the first terminal device; or an identifier of the associated device of the first terminal device.

Optionally, the communication apparatus 1400 further includes: a first transmitting module 1420, configured to transmit a second message, where the second message is used to indicate a third network element to perform QoS monitoring on the first packet delay.

Optionally, in a case where the first packet delay is the packet delay between the first associated device of the first terminal device and the second associated device, forwarded via the UPF, the second message is used to indicate the third network element to perform monitoring on a second packet delay and a third packet delay, respectively; where the second packet delay is a packet delay between the first associated device and the UPF, and the third packet delay is a packet delay between the second associated device and the UPF; where the second associated device is the associated device of the first terminal device, or the second associated device is the associated device of the second terminal device.

Optionally, in a case where the first packet delay is the packet delay between the first associated device of the first terminal device and the second associated device, forwarded via the DN, the second message is used to indicate the third network element to perform monitoring on a second packet delay and a third packet delay, respectively; where the second packet delay is a packet delay between the first associated device and the DN, and the third packet delay is a packet delay between the second associated device and the DN; where the second associated device is the associated device of the first terminal device, or the second associated device is the associated device of the second terminal device.

Optionally, in a case where the first packet delay is the packet delay between the first terminal device and the associated device of the first terminal device, forwarded via the UPF, the second message is used to indicate the third network element to perform monitoring on a second packet delay and a third packet delay, respectively; where the second packet delay is a packet delay between the first terminal device and the UPF, and the third packet delay is a packet delay between the associated device of the first terminal device and the UPF; or the second packet delay is a round-trip packet delay between the first terminal device and the UPF, and the third packet delay is the packet delay between the first terminal device and the associated device of the first terminal device.

Optionally, in a case where the first packet delay is the packet delay between the first terminal device and the associated device of the first terminal device, forwarded via the DN, the second message is used to indicate the third network element to perform monitoring on a second packet delay and a third packet delay, respectively; where the second packet delay is a packet delay between the first terminal device and the DN, and the third packet delay is a packet delay between the associated device of the first terminal device and the DN; or the second packet delay is a round-trip packet delay between the first terminal device and the DN, and the third packet delay is the packet delay between the first terminal device and the associated device of the first terminal device.

Optionally, in a case where the first packet delay is the packet delay between the second terminal device and the associated device of the first terminal device, forwarded via the UPF, the second message is used to indicate the third network element to perform monitoring on a second packet delay and a third packet delay, respectively; where the second packet delay is a packet delay between the second terminal device and the UPF, and the third packet delay is a packet delay between the associated device of the first terminal device and the UPF.

Optionally, in a case where the first packet delay is the packet delay between the second terminal device and the associated device of the first terminal device, forwarded via the DN, the second message is used to indicate the third network element to perform monitoring on a second packet delay and a third packet delay, respectively; where the second packet delay is a packet delay between the second terminal device and the DN, and the third packet delay is a packet delay between the associated device of the first terminal device and the DN.

Optionally, the communication apparatus further includes: a second receiving module, configured to receive a monitoring result of the second packet delay and a monitoring result of the third packet delay from the third network element; and a second transmitting module, configured to transmit a monitoring result of the first packet delay to the first network element according to the monitoring result of the second packet delay and the monitoring result of the third packet delay.

Optionally, the communication apparatus further includes: a third receiving module, configured to receive a monitoring result from the third network element; and a third transmitting module, configured to transmit the monitoring result to the first network element; where the monitoring result includes one or more of: the first packet delay; or a segment delay in the first packet delay.

Optionally, the first packet delay is an end-to-end packet delay between two communication nodes, and the segment delay includes a packet delay between two adjacent nodes through which a data transmission path between the two communication nodes passes.

Optionally, the third network element is an SMF.

Optionally, the first network element is an AF, a network element in a core network, or a terminal device.

Optionally, the second network element is a PCF.

Optionally, the associated device of the first terminal device is a device that communicates with a mobile communication network through the first terminal device.

Optionally, the associated device of the first terminal device is a 3GPP terminal device, or the associated device of the first terminal device is a non-3GPP device.

Optionally, the first receiving module 1410 may be a transceiver 1830. The communication apparatus 1400 may further include a processor 1810 and a memory 1820, as illustrated in FIG. 18.

FIG. 15 is a schematic structural diagram of a communication apparatus provided by yet another embodiment of the present application. The communication apparatus 1500 illustrated in FIG. 15 may be any third network element described above. The communication apparatus 1500 may include a first receiving module 1510.

The first receiving module 1510 may be configured to receive a second message transmitted by a second network element, the second message being used to indicate the third network element to perform QoS monitoring on a first packet delay; where the first packet delay includes one or more of following packet delays: a packet delay between a first terminal device and an associated device of the first terminal device; or a packet delay between a UPF and a DN.

Optionally, the first packet delay is one of the following packet delays: a packet delay between the DN and the associated device of the first terminal device; a packet delay between the UPF and the associated device of the first terminal device; the packet delay between the first terminal device and the associated device of the first terminal device; the packet delay between the UPF and the DN; a packet delay between a first associated device of the first terminal device and a second associated device, forwarded via the UPF; a packet delay between the first associated device of the first terminal device and the second associated device, forwarded via the DN; a packet delay between the first terminal device and the associated device of the first terminal device, forwarded via the UPF; a packet delay between the first terminal device and the associated device of the first terminal device, forwarded via the DN; a packet delay between a second terminal device and the associated device of the first terminal device, forwarded via the UPF; or a packet delay between the second terminal device and the associated device of the first terminal device, forwarded via the DN; where the second associated device is the associated device of the first terminal device, or the second associated device is an associated device of the second terminal device.

Optionally, the first packet delay includes one or more of: an uplink delay; a downlink delay; or a round-trip time.

Optionally, in a case where the first packet delay includes the packet delay between the first terminal device and the associated device of the first terminal device, the second message includes one or more of: an address of the associated device of the first terminal device; or an identifier of the associated device of the first terminal device.

Optionally, the communication apparatus further includes: a first transmitting module 1520, configured to transmit a third message to a fourth network element in a case where the first packet delay includes the packet delay between the UPF and the DN, where the third message is used to request the fourth network element to perform QoS monitoring on the packet delay between the UPF and the DN.

Optionally, the communication apparatus further includes: a second transmitting module, configured to transmit a fourth message to the first terminal device in a case where the first packet delay includes the packet delay between the first terminal device and the associated device of the first terminal device, where the fourth message is used to request the first terminal device to perform QoS monitoring on the packet delay between the first terminal device and the associated device of the first terminal device.

Optionally, the fourth message is used to request the first terminal device to perform QoS monitoring on one or more of: an uplink packet delay and/or a downlink packet delay between the first terminal device and the first associated device of the first terminal device; packet delays between the first terminal device and multiple associated devices of the first terminal device; or a one-way packet delay between the first terminal device and the first associated device of the first terminal device.

Optionally, the communication apparatus further includes: a second receiving module, configured to receive a monitoring result from a fourth network element, where the monitoring result includes one or more of: the first packet delay; or a segment delay in the first packet delay.

Optionally, the communication apparatus further includes: a third transmitting module, configured to transmit the monitoring result to the second network element.

Optionally, the first packet delay is an end-to-end packet delay between two communication nodes, and the segment delay includes a packet delay between two adjacent nodes through which a data transmission path between the two communication nodes passes.

Optionally, the fourth network element is the UPF.

Optionally, the second network element is a PCF.

Optionally, the third network element is an SMF.

Optionally, the associated device of the first terminal device is a device that communicates with a mobile communication network through the first terminal device.

Optionally, the associated device of the first terminal device is a 3GPP terminal device, or the associated device of the first terminal device is a non-3GPP device.

Optionally, the first receiving module 1510 may be a transceiver 1830. The communication apparatus 1500 may further include a processor 1810 and a memory 1820, as illustrated in FIG. 18.

FIG. 16 is a schematic structural diagram of a communication apparatus provided by yet another embodiment of the present application. The communication apparatus 1600 illustrated in FIG. 16 may be any fourth network element described above. The communication apparatus 1600 may include a first receiving module 1610.

The first receiving module 1610 may be configured to receive a third message transmitted by a third network element, where the third message is used to request the fourth network element to perform QoS monitoring on a packet delay between a UPF and a DN.

Optionally, the packet delay between the UPF and the DN includes one or more of: an uplink delay; a downlink delay; or a round-trip time.

Optionally, the communication apparatus further includes: a second receiving module 1620, configured to receive a fifth message transmitted by a fifth network element, where the fifth message includes one or more of: a packet delay between an access network device and a first terminal device; or a packet delay between the first terminal device and an associated device of the first terminal device.

Optionally, the communication apparatus further includes: a determining module, configured to determine a monitoring result according to a packet delay in the fifth message and a packet delay monitored by the fourth network element, where the monitoring result includes one or more of: a first packet delay for which monitoring is requested; or a segment delay in the first packet delay.

Optionally, the communication apparatus further includes: a first transmitting module, configured to transmit the monitoring result to the third network element; or a second transmitting module, configured to directly transmit the monitoring result to a network element that requests the QoS monitoring.

Optionally, the first packet delay is one of following packet delays: a packet delay between the DN and the associated device of the first terminal device; a packet delay between the UPF and the associated device of the first terminal device; the packet delay between the first terminal device and the associated device of the first terminal device; the packet delay between the UPF and the DN; a packet delay between a first associated device of the first terminal device and a second associated device, forwarded via the UPF; a packet delay between the first associated device of the first terminal device and the second associated device, forwarded via the DN; a packet delay between the first terminal device and the associated device of the first terminal device, forwarded via the UPF; a packet delay between the first terminal device and the associated device of the first terminal device, forwarded via the DN; a packet delay between a second terminal device and the associated device of the first terminal device, forwarded via the UPF; or a packet delay between the second terminal device and the associated device of the first terminal device, forwarded via the DN; where the second associated device is the associated device of the first terminal device, or the second associated device is an associated device of the second terminal device.

Optionally, the first packet delay includes one or more of: an uplink delay; a downlink delay; or a round-trip time.

Optionally, the first packet delay is an end-to-end packet delay between two communication nodes, and the segment delay includes a packet delay between two adjacent nodes through which a data transmission path between the two communication nodes passes.

Optionally, the fifth network element is the access network device.

Optionally, the associated device of the first terminal device is a device that communicates with a mobile communication network through the first terminal device.

Optionally, the associated device of the first terminal device is a 3GPP terminal device, or the associated device of the first terminal device is a non-3GPP device.

Optionally, the fourth network element is the UPF.

Optionally, the third network element is an SMF.

Optionally, the first receiving module 1610 may be a transceiver 1830. The communication apparatus 1600 may further include a processor 1810 and a memory 1820, as illustrated in FIG. 18.

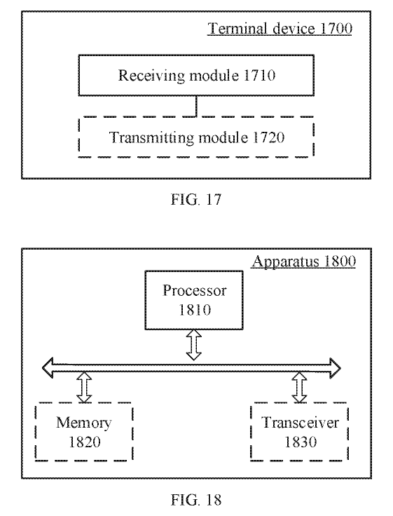

FIG. 17 is a schematic structural diagram of a terminal device provided by the embodiments of the present application. The terminal device 1700 illustrated in FIG. 17 may include a receiving module 1710.

The receiving module 1710 may be configured to receive a fourth message transmitted by a third network element, where the fourth message is used to request the first terminal device to perform QoS monitoring on a packet delay between the first terminal device and an associated device of the first terminal device.

Optionally, the fourth message includes one or more of: an address of the associated device of the first terminal device; or an identifier of the associated device of the first terminal device.

Optionally, the terminal device further includes: a transmitting module 1720, configured to transmit a monitoring result to a fourth network element, where the monitoring result includes one or more of: an uplink packet delay and/or a downlink packet delay between the first terminal device and a first associated device of the first terminal device; packet delays between the first terminal device and multiple associated devices of the first terminal device; or a one-way packet delay between the first terminal device and the first associated device of the first terminal device.

Optionally, the fourth network element is a UPF.

Optionally, the third network element is an SMF.

Optionally, the associated device of the first terminal device is a device that communicates with a mobile communication network through the first terminal device.

Optionally, the associated device of the first terminal device is a 3GPP terminal device, or the associated device of the first terminal device is a non-3GPP device.

Optionally, the receiving module 1710 may be a transceiver 1830. The terminal device 1700 may further include a processor 1810 and a memory 1820, as illustrated in FIG. 18.

FIG. 18 is a schematic structural diagram of a communication apparatus according to the embodiments of the present application. The dashed lines in FIG. 18 indicate that the unit or module is optional. The apparatus 1800 may be configured to implement the methods described in the above method embodiments. The apparatus 1800 may be a chip, a terminal device, or a network device.

The apparatus 1800 may include one or more processors 1810. The processor 1810 may support the apparatus 1800 to implement the methods described in the above method embodiments. The processor 1810 may be a general-purpose processor or a dedicated processor. For example, the processor may be a central processing unit (CPU). Alternatively, the processor may be another general-purpose processor, a digital signal processor (DSP), an application specific integrated circuits (ASIC), a field programmable gate array (FPGA) or other programmable logic devices, discrete gates or transistor logic devices, discrete hardware components, and so on. The general-purpose processor may be a microprocessor, or the processor may be any conventional processor or the like.

The apparatus 1800 may further include one or more memories 1820. The memory 1820 has a program stored thereon, and the program may be performed by the processor 1810, to enable the processor 1810 to perform the methods described in the above method embodiments. The memory 1820 may be independent of the processor 1810 or may be integrated into the processor 1810.

The apparatus 1800 may further include a transceiver 1830. The processor 1810 may communicate with other devices or chips through the transceiver 1830. For example, the processor 1810 may transmit and receive data with other devices or chips through the transceiver 1830.

The embodiments of the present application further provide a non-transitory computer-readable storage medium for storing a program. The non-transitory computer-readable storage medium may be applied to a terminal or network device provided by the embodiments of the present application, and the program enables a computer to perform the methods performed by the terminal or network device in various embodiments of the present application.

The embodiments of the present application further provide a computer program product. The computer program product includes a program. The computer program product may be applied to a terminal or network device provided by the embodiments of the present application, and the program enables a computer to perform the methods performed by the terminal or network device in various embodiments of the present application.

The embodiments of the present application further provide a computer program. The computer program may be applied to a terminal or network device provided by the embodiments of the present application, and the computer program enables a computer to perform the methods performed by the terminal or network device in various embodiments of the present application.

It is to be understood that the terms "system" and "network" may be used interchangeably in the present application. In addition, the terms used in the present application are only used to explain the embodiments of the present application and are not intended to limit the present application. The terms "first", "second", "third" and "fourth" in the specification, claims and drawings of the present application are used to distinguish different objects rather than to describe a specific order. In addition, the terms "include", "comprise", "have" , and any variations thereof, are intended to cover a non-exclusive inclusion.

In the embodiments of the present application, the "indication" mentioned may be a direct indication, an indirect indication, or an indication of an association relationship. For example, A indicates B, which may mean that A directly indicates B, for example, B may be obtained through A; it may also mean that A indirectly indicates B, for example, A indicates C, and B may be obtained through C; it may also mean that there is an association relationship between A and B.

In the embodiments of the present application, "B corresponding to A" means that B is associated with A, and B may be determined based on A. However, it is also to be understood that determining B based on A does not mean determining B based solely on A, and B may also be determined based on A and/or other information.

In the embodiments of the present application, the term "corresponding" may indicate a direct or indirect correspondence between the two, or an association relationship between the two, or a relationship between indicating and being indicated, configuring and being configured, or the like.

In the embodiments of the present application, the word "include" mentioned may refer to direct inclusion or indirect inclusion. Optionally, "including" mentioned in the embodiments of the present application may be replaced with "indicate" or "used to determine". For example, A includes B may be replaced by A indicates B, or A is used to determine B.

In the embodiments of the present application, "predefine" or "preconfigure" may be achieved by pre-saving corresponding codes, tables or other methods that may be used to indicate relevant information in a device (e.g., including a terminal device and a network device), the implementation is not limited in the present application. For example, predefine may refer to that defined in the protocol.

In the embodiments of the present application, the "protocol" may refer to a standard protocol in the communications field, for example, may include an LTE protocol, an NR protocol, and related protocols used in future communication systems, which is not limited in the present application.

In the embodiments of the present application, the term "and/or" is merely a description of an association relationship between associated objects, indicating that three relationships may exist. For example, A and/or B may represent three cases: A alone, A and B both, and B alone. In addition, the character "/" in the present application generally indicates that related objects before and after the character are in an "or" relationship.

In various embodiments of the present application, the magnitude of the serial number of each of the above-mentioned processes does not mean the order of execution. The order of execution of each process shall be determined by its function and internal logic, and shall not constitute any limitation on the implementation process of the embodiments of the present application.

In the several embodiments provided by the present application, it is to be understood that, the disclosed systems, apparatuses, and methods may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto multiple network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

The above embodiments may be implemented in whole or in part through software, hardware, firmware, or any combination thereof. When the embodiments are implemented by using a software program, the software program may be implemented in a form of a computer program product in whole or in part. The computer program product includes one or more computer instructions. When computer program instructions are loaded on and executed by a computer, processes or functions according to the embodiments of the present application are generated in whole or in part. The computer may be a general-purpose computer, a dedicated computer, a computer network, or any other programmable device. The computer instructions may be stored in a computer-readable storage medium or transmitted from a computer-readable storage medium to another computer-readable storage medium. For example, the computer instructions may be transmitted from a website, computer, server or data center to another website, computer, server or data center via a wired manner (such as coaxial cable, optical fiber, or digital subscriber line (DSL)) or a wireless manner (such as infrared, wireless or microwave). The computer-readable storage medium may be any available medium able to be accessed by the computer, or may be a data storage device, such as a server or a data center, integrated by one or more available media. The available medium may be a magnetic medium (e.g., a floppy disk, a hard disk or a magnetic tape), an optical medium (e.g., a DVD), a semiconductor medium (e.g., a solid state drive (SSD)), or the like.

The above content is only exemplary implementations of the present application, but the protection scope of the present application is not limited thereto, and any skilled familiar with the technical field may easily think of changes or substitutions within the technical scope disclosed in the present application, which should be all covered within the protection scope of the present application. Therefore, the protection scope of the present application should be subject to the protection scope of the claims.

What is claimed is:

1. A first network element, comprising: a transceiver, a memory and a processor, wherein the memory is configured to store a program, and the processor is configured to call the program stored in the memory, to enable the first network element to perform:
transmitting a first message to a second network element, the first message being used to request quality of service (QoS) monitoring for a first packet delay;
wherein the first packet delay comprises one or more of following packet delays:
a packet delay between a first terminal device and an associated device of the first terminal device; or
a packet delay between a user plane function (UPF) and a data network (DN).

2. The first network element according to claim 1, wherein the first packet delay is one of following packet delays:
a packet delay between the DN and the associated device of the first terminal device;
a packet delay between the UPF and the associated device of the first terminal device;
the packet delay between the first terminal device and the associated device of the first terminal device;
the packet delay between the UPF and the DN;
a packet delay between a first associated device of the first terminal device and a second associated device, forwarded via the UPF;
a packet delay between the first associated device of the first terminal device and the second associated device, forwarded via the DN;
a packet delay between the first terminal device and the associated device of the first terminal device, forwarded via the UPF;
a packet delay between the first terminal device and the associated device of the first terminal device, forwarded via the DN;
a packet delay between a second terminal device and the associated device of the first terminal device, forwarded via the UPF; or
a packet delay between the second terminal device and the associated device of the first terminal device, forwarded via the DN;
wherein the second associated device is the associated device of the first terminal device, or the second associated device is an associated device of the second terminal device.

3. The first network element according to claim 1, wherein the first packet delay comprises one or more of:
an uplink delay;
a downlink delay; or
a round-trip time.

4. The first network element according to claim 1, wherein in a case where the first packet delay comprises the packet delay between the first terminal device and the associated device of the first terminal device, the first message comprises one or more of:
an address of the associated device of the first terminal device; or
an identifier of the associated device of the first terminal device.

5. The first network element according to claim 1, wherein the processor is configured to call the program stored in the memory, to enable the first network element to further perform:
receiving a monitoring result, wherein the monitoring result comprises one or more of:
the first packet delay; or
a segment delay in the first packet delay.

6. The first network element according to claim 5, wherein the first packet delay is an end-to-end packet delay between two communication nodes, and the segment delay comprises a packet delay between two adjacent nodes through which a data transmission path between the two communication nodes passes.

7. The first network element according to claim 1, wherein the first network element is an application function (AF), a network element in a core network or a terminal device; or
the second network element is a policy control function (PCF).

8. The first network element according to claim 1, wherein the associated device of the first terminal device is a device that communicates with a mobile communication network through the first terminal device; or
the associated device of the first terminal device is a 3rd Generation Partnership Project (3GPP) terminal device, or the associated device of the first terminal device is a non-3GPP device.

9. A second network element, comprising: a transceiver, a memory and a processor, wherein the memory is configured to store a program, and the processor is configured to call the program stored in the memory, to enable the second network element to perform:
receiving a first message transmitted by a first network element, the first message being used to request quality of service (QoS) monitoring for a first packet delay;
wherein the first packet delay comprises one or more of following packet delays:
a packet delay between a first terminal device and an associated device of the first terminal device; or
a packet delay between a user plane function (UPF) and a data network (DN).

10. The second network element according to claim 9, wherein the first packet delay is one of following packet delays:
a packet delay between the DN and the associated device of the first terminal device;
a packet delay between the UPF and the associated device of the first terminal device;
the packet delay between the first terminal device and the associated device of the first terminal device;
the packet delay between the UPF and the DN;
a packet delay between a first associated device of the first terminal device and a second associated device, forwarded via the UPF;
a packet delay between the first associated device of the first terminal device and the second associated device, forwarded via the DN;
a packet delay between the first terminal device and the associated device of the first terminal device, forwarded via the UPF;
a packet delay between the first terminal device and the associated device of the first terminal device, forwarded via the DN;
a packet delay between a second terminal device and the associated device of the first terminal device, forwarded via the UPF; or
a packet delay between the second terminal device and the associated device of the first terminal device, forwarded via the DN;
wherein the second associated device is the associated device of the first terminal device, or the second associated device is an associated device of the second terminal device.

11. The second network element according to claim 9, wherein the first packet delay comprises one or more of:
an uplink delay;
a downlink delay; or
a round-trip time.

12. The second network element according to claim 9, wherein in a case where the first packet delay comprises the packet delay between the first terminal device and the associated device of the first terminal device, the first message comprises one or more of:
an address of the associated device of the first terminal device; or
an identifier of the associated device of the first terminal device.

13. The second network element according to claim 9, wherein the processor is configured to call the program stored in the memory, to enable the second network element to further perform:
transmitting a second message to a third network element, the second message being used to indicate the third network element to perform QoS monitoring on the first packet delay.

14. The second network element according to claim 13, wherein in a case where the first packet delay is a packet delay between a first associated device of the first terminal device and a second associated device, forwarded via the UPF, the second message is used to indicate the third network element to perform monitoring on a second packet delay and a third packet delay, respectively;
wherein the second packet delay is a packet delay between the first associated device and the UPF, and the third packet delay is a packet delay between the second associated device and the UPF; and
the second associated device is the associated device of the first terminal device, or the second associated device is an associated device of a second terminal device.

15. The second network element according to claim 13, wherein in a case where the first packet delay is a packet delay between a first associated device of the first terminal device and a second associated device, forwarded via the DN, the second message is used to indicate the third network element to perform monitoring on a second packet delay and a third packet delay, respectively;
wherein the second packet delay is a packet delay between the first associated device and the DN, and the third packet delay is a packet delay between the second associated device and the DN; and
the second associated device is the associated device of the first terminal device, or the second associated device is an associated device of a second terminal device.

16. The second network element according to claim 13, wherein in a case where the first packet delay is a packet delay between the first terminal device and the associated device of the first terminal device, forwarded via the UPF, the second message is used to indicate the third network element to perform monitoring on a second packet delay and a third packet delay, respectively;
wherein the second packet delay is a packet delay between the first terminal device and the UPF, and the third packet delay is a packet delay between the associated device of the first terminal device and the UPF; or
the second packet delay is a round-trip packet delay between the first terminal device and the UPF, and the third packet delay is the packet delay between the first terminal device and the associated device of the first terminal device.

17. The second network element according to claim 13, wherein in a case where the first packet delay is a packet delay between the first terminal device and the associated device of the first terminal device, forwarded via the DN, the second message is used to indicate the third network element to perform monitoring on a second packet delay and a third packet delay, respectively;
wherein the second packet delay is a packet delay between the first terminal device and the DN, and the third packet delay is a packet delay between the associated device of the first terminal device and the DN; or
the second packet delay is a round-trip packet delay between the first terminal device and the DN, and the third packet delay is the packet delay between the first terminal device and the associated device of the first terminal device.

18. The second network element according to claim 13, wherein in a case where the first packet delay is a packet delay between a second terminal device and the associated device of the first terminal device, forwarded via the UPF, the second message is used to indicate the third network element to perform monitoring on a second packet delay and a third packet delay, respectively;
wherein the second packet delay is a packet delay between the second terminal device and the UPF, and the third packet delay is a packet delay between the associated device of the first terminal device and the UPF;
or
in a case where the first packet delay is a packet delay between a second terminal device and the associated device of the first terminal device, forwarded via the DN, the second message is used to indicate the third network element to perform monitoring on a second packet delay and a third packet delay, respectively;
wherein the second packet delay is a packet delay between the second terminal device and the DN, and the third packet delay is a packet delay between the associated device of the first terminal device and the DN.

19. The second network element according to claim 14, wherein the processor is configured to call the program stored in the memory, to enable the second network element to further perform:
receiving a monitoring result of the second packet delay and a monitoring result of the third packet delay from the third network element; and
transmitting a monitoring result of the first packet delay to the first network element according to the monitoring result of the second packet delay and the monitoring result of the third packet delay.

20. The second network element according to claim 13, wherein the processor is configured to call the program stored in the memory, to enable the second network element to further perform:
receiving a monitoring result from the third network element; and
transmitting the monitoring result to the first network element;
wherein the monitoring result comprises one or more of:
the first packet delay; or
a segment delay in the first packet delay;
wherein the first packet delay is an end-to-end packet delay between two communication nodes, and the segment delay comprises a packet delay between two adjacent nodes through which a data transmission path between the two communication nodes passes.
